(19) United States
(12) Patent Application Publication
(10) Pub. No.: US 2022/0043506 A1
(43) Pub. Date: Feb. 10, 2022

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Taro YOSHIHAMA, Kanagawa (JP)

(73) Assignee: FUJIFILM Business Innovation Corp., Tokyo (JP)

(21) Appl. No.: 17/146,445

(22) Filed: Jan. 11, 2021

(30) Foreign Application Priority Data
Aug. 5, 2020 (JP) 2020-133265

(51) Int. Cl. G06F 3/01; G06T 7/73

(52) U.S. Cl. CPC G06F 3/011; G06T 7/73; G06F 3/017

(57) ABSTRACT

An information processing apparatus includes a processor configured to detect a free area of an object in a real space, acquire an arrangement of plural virtual objects, and cause the plural virtual objects to be displayed in the free area, in the acquired arrangement.

### CROSS-REFERENCE TO RELATED APPLICATIONS

This application is based on and claims priority under 35 USC 119 from Japanese Patent Application No. 2020-133265 filed Aug. 5, 2020.

### BACKGROUND

### (i) Technical Field

The present invention relates to an information processing apparatus and a non-transitory computer readable medium storing an information processing program.

### (ii) Related Art

JP4663077B discloses an object verification method. The object verification method of JP4663077B is a method of verifying whether or not a preselected object that is able to be used as an interface tool of a system exists in an image projected in a view plane of an augmented reality display system based on image data obtained by photographing a predetermined area by photographing means.

The object verification method includes an identification step, a calculation step, and a verification step. In the identification step, positions of a plurality of predetermined feature points of a candidate object, which is a candidate of the object expected to exist in the image projected on the view plane, on the image are identified. In the calculation step, a reference position, which is a reference for photographing of the photographing means, is positioned at a viewpoint of a person viewing the view plane, and an actual position of the candidate object in the predetermined area is calculated based on the position of the viewpoint and the position of the plurality of feature points of the identified candidate object. In the verification step, whether or not the candidate object is the object is verified based on the actual position of the calculated candidate object in the predetermined area and a predetermined geometric condition that the calculated actual position of the candidate object should satisfy in a case where the candidate object is the object.

The object verification method further includes a detection step, a determination step, and a change step. In the detection step, a movement of a hand or finger and voice of the person viewing the view plane are predetermined in response to a command to change the projected image to another projected image, and the voice of the person viewing the view plane is detected by voice detecting means. In the determination step, based on the image data obtained by photographing by the photographing means and the voice detected by the voice detecting means, whether or not a movement of the hand or finger and the voice of the person viewing the view plane are the movement and voice predetermined in response to the command is determined. In the change step, in a case where it is determined that a movement of the hand or finger and voice of the person viewing the view plane are the movement and voice predetermined in response to the command, the projected image is changed to another projected image.

JP2019-101796A discloses an information processing apparatus. The information processing apparatus of JP2019-101796A includes image information acquisition means and creation means. The image information acquisition means acquires image information of input means from a photographing apparatus that photographs an image of the input means that performs an input of information. The creation means creates display information for a display apparatus that displays the image of the input means based on the image information, and updates the display information for the display apparatus according to the information input by using the input means displayed on the display apparatus.

### SUMMARY

In a case of displaying a virtual document in a specific place in a real space (for example, on a desk), there is a case where, even though there is a physical object in the specific place, the existence of the object is ignored and the document is displayed. In such a case, in a case where an attempt is made to operate the document while the document is displayed, the object becomes an obstacle. Therefore, it is required to display a document in a free area, which is an area in which a document is able to be displayed, in a specific place.

By the way, in a case of operating a document, a user may operate a plurality of documents by displaying a plurality of documents. At this time, the user may work by giving meaning to an arrangement of a plurality of documents, and in this case, in a case where the plurality of documents are misaligned and displayed, it may be inconvenient for the user.

Aspects of non-limiting embodiments of the present disclosure relate to an information processing apparatus and a non-transitory computer readable medium storing an information processing program that are capable of maintaining and displaying an arrangement of a plurality of virtual objects in a case of displaying a plurality of virtual objects in a free area in a specific place in a real space.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

In order to address the above-described problems, according to an aspect of the present disclosure, there is provided an information processing apparatus including a processor, and the processor detects a free area of an object in a real space, acquires an arrangement of a plurality of virtual objects, and causes the plurality of virtual objects to be displayed in the free area in the acquired arrangement.

### BRIEF DESCRIPTION OF THE DRAWINGS

Exemplary embodiment(s) of the present invention will be described in detail based on the following figures, wherein:

FIG. 1 shows a configuration of an information processing apparatus JS of a first exemplary embodiment;

FIG. 2 is a functional block diagram of an information processing apparatus JS of a first exemplary embodiment;

FIG. 3 shows document group information BJ of a first exemplary embodiment;

FIG. 4 shows bibliographic information SJ of a first exemplary embodiment;

FIG. 5 shows a document layout BH of a first exemplary embodiment;

FIG. 6 is a flowchart showing an operation of an information processing apparatus JS of a first exemplary embodiment;

FIG. 7 shows a desk TK in a real space GK of a first exemplary embodiment;

FIG. 8 shows a free area AR in a real space GK of a first exemplary embodiment;

FIG. 9 shows a menu MN in a virtual space KK of a first exemplary embodiment;

FIG. 10 shows a desk TK and a menu MN in a composite space FK of a first exemplary embodiment;

FIG. 11 shows an arrangement of documents BS1 to BS25 in a virtual space KK of a first exemplary embodiment;

FIG. 12 shows a display of a desk TK, a free area AR, and documents BS1 to BS25 in a composite space FK of a first exemplary embodiment;

FIG. 13 is a flowchart showing an operation of an information processing apparatus JS of a second exemplary embodiment;

FIG. 14 shows a desk TK, a computer PC, papers PA, a writing instrument PE, and a free area AR in a real space GK of a second exemplary embodiment;

FIG. 15 shows an arrangement of documents BS1 to BS25 in a virtual space KK of a second exemplary embodiment;

FIG. 16 shows a display of a desk TK, a free area AR, and documents BS1 to BS25 in a composite space FK of a second exemplary embodiment;

FIG. 17 shows an arrangement of documents BS1 to BS25 in a virtual space KK of a modified example of a second exemplary embodiment;

FIG. 18 shows a display of a desk TK, a free area AR, and documents BS1 to BS25 in a composite space FK of a modified example of a second exemplary embodiment;

FIG. 19 is a flowchart showing an operation of an information processing apparatus JS of a third exemplary embodiment;

FIG. 20 shows a menu MN in a composite space FK of a third exemplary embodiment;

FIG. 21 shows a document layout BH of a third exemplary embodiment;

FIG. 22 shows an arrangement of documents BS1 to BS4 and BS6 to BS9 in a virtual space KK of a third exemplary embodiment;

FIG. 23 shows a display of a desk TK, a free area AR, documents BS1 to BS4 and BS6 to BS9 in a composite space FK of a third exemplary embodiment;

FIG. 24 is a flowchart showing an operation of an information processing apparatus JS of a fourth exemplary embodiment;

FIG. 25 shows an arrangement of an auxiliary mark HM in a virtual space KK of a fourth exemplary embodiment;

FIG. 26 shows a display of a desk TK, a free area AR, documents BS1 to BS15, and an auxiliary mark HM in a composite space FK of a fourth exemplary embodiment;

FIG. 27 is a flowchart showing an operation of an information processing apparatus JS of a fifth exemplary embodiment;

FIG. 28 shows a document layout BH of a last time of a fifth exemplary embodiment;

FIG. 29 shows an arrangement of documents BS1, BS2, . . . of a this time in a virtual space KK of a fifth exemplary embodiment;

FIG. 30 shows a display of a desk TK, a free area AR, and documents BS1, BS2, . . . of this time in a composite space FK of a fifth exemplary embodiment;

FIG. 31 is a flowchart showing an operation of an information processing apparatus JS of a sixth exemplary embodiment;

FIG. 32 shows a document layout BH of a sixth exemplary embodiment;

FIG. 33 shows an arrangement of documents BS1, BS2, . . . in a virtual space KK of a sixth exemplary embodiment;

FIG. 34 shows a display of a desk TK, a free area AR, and documents BS1, BS2, . . . in a composite space FK of a sixth exemplary embodiment;

FIG. 35 is a flowchart showing an operation of an information processing apparatus JS according to a seventh exemplary embodiment;

FIG. 36 shows documents BS1, BS2, . . . before a movement in a composite space FK of a seventh exemplary embodiment;

FIG. 37 shows an arrangement of documents BS1, BS2, . . . in a virtual space KK of a seventh exemplary embodiment;

FIG. 38 shows a display of a desk TK, a free area AR, and documents BS1, BS2, . . . after a movement in a composite space FK of a seventh exemplary embodiment;

FIG. 39 is a flowchart showing an operation of an information processing apparatus JS of an eighth exemplary embodiment;

FIG. 40 shows documents BS1, BS2, . . . in a composite space FK of an eighth exemplary embodiment;

FIG. 41 shows an arrangement of documents BS1, BS2, . . . in outer areas SR1 and SR2 in a virtual space KK of an eighth exemplary embodiment;

FIG. 42 shows a display of a desk TK, a free area AR, documents BS1, BS2, . . . in a composite space FK of an eighth exemplary embodiment;

FIG. 43 is a flowchart showing an operation of an information processing apparatus JS of a ninth exemplary embodiment;

FIG. 44 shows documents BS1, BS2, . . . in a composite space FK of a ninth exemplary embodiment;

FIG. 45 shows an eye ME in a front side area RY2 of a composite space FK of a ninth exemplary embodiment;

FIG. 46 shows a display of a desk TK, a free area AR, and enlarged documents BS1, BS2, . . . in a composite space FK of a ninth exemplary embodiment;

FIG. 47 shows a display of a desk TK, a free area AR, and further enlarged documents BS1, BS2, . . . in a composite space FK of a ninth exemplary embodiment;

FIG. 48 shows an eye ME in an inner side area RY1 of a composite space FK of a ninth exemplary embodiment;

FIG. 49 shows a display of a desk TK, a free area AR, and reduced documents BS1, BS2, . . . in a composite space FK of a ninth exemplary embodiment;

FIG. 50 shows a display of a desk TK, a free area AR, and further reduced documents BS1, BS2, . . . in a composite space FK of a ninth exemplary embodiment;

FIG. 51 is a flowchart showing an operation of an information processing apparatus JS of a tenth exemplary embodiment;

FIG. 52 shows documents BS1, BS2, . . . in a composite space FK of a tenth exemplary embodiment;

FIG. 53 shows a movement of a document BS3 in a composite space FK of a tenth exemplary embodiment;

FIG. 54 shows a desk TK, a free area AR, documents BS1, BS2, . . . , and a documents BS3 after a movement in a composite space FK of a tenth exemplary embodiment;

FIG. 55 is a flowchart showing an operation of an information processing apparatus JS of an eleventh exemplary embodiment;

FIG. 56 shows a gesture of picking up a document BS3 in a composite space FK of an eleventh exemplary embodiment;

FIG. 57 shows a display of an enlarged document BS3 in a composite space FK of an eleventh exemplary embodiment;

FIG. 58 shows a gesture of picking up a document BS1 in a composite space FK of an eleventh exemplary embodiment;

FIG. 59 shows a display of an enlarged document BS1 in a composite space FK of an eleventh exemplary embodiment;

FIG. 60 shows a gesture of returning a document BS1 in a composite space FK of an eleventh exemplary embodiment; and

FIG. 61 shows a display of a document BS1 of an original size in a composite space FK of an eleventh exemplary embodiment.

### DETAILED DESCRIPTION

### First Exemplary Embodiment

A first exemplary embodiment of an information processing apparatus JS according to an exemplary embodiment of the invention will be described.

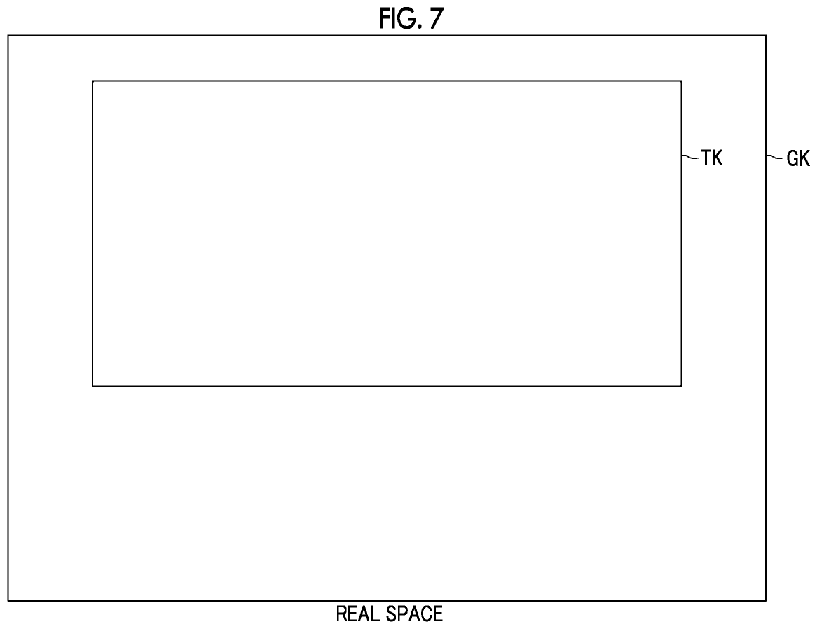

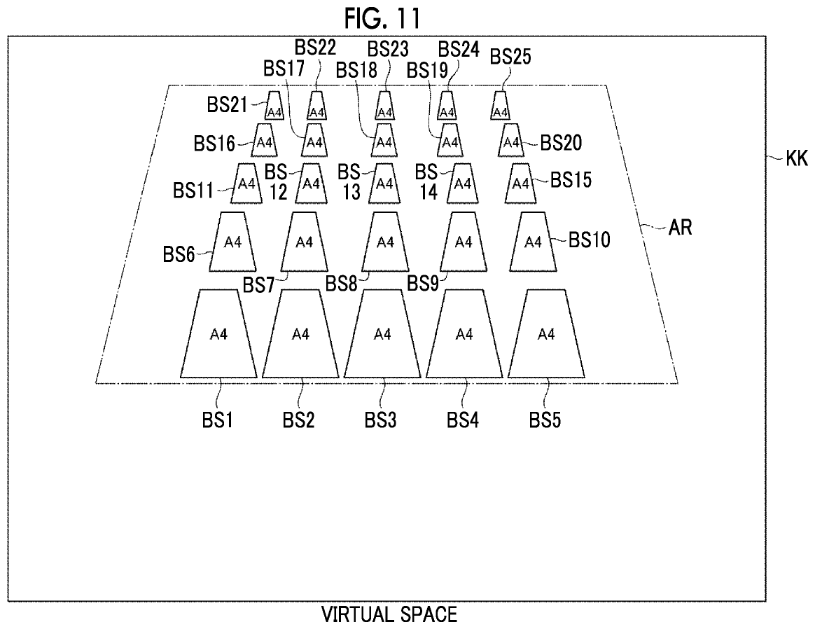

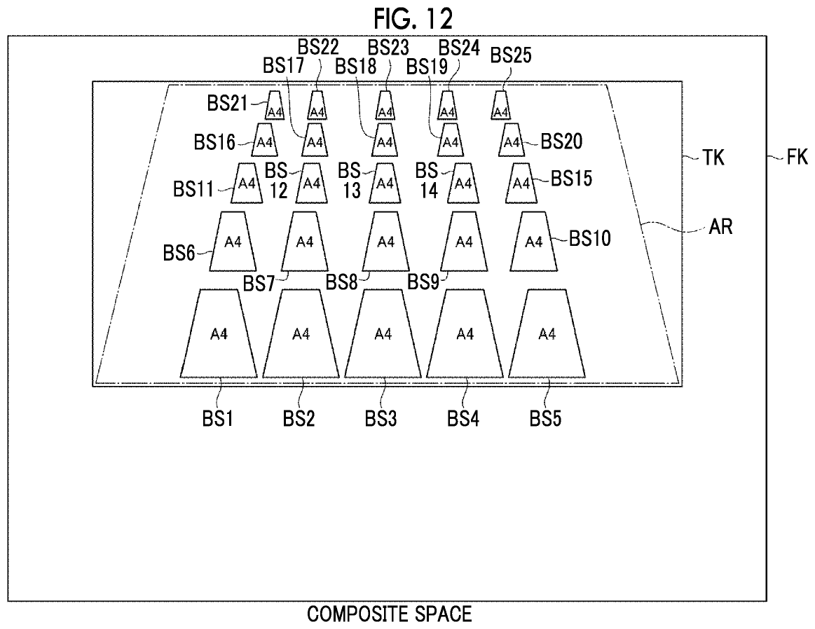

The information processing apparatus JS of the first exemplary embodiment is, for example, a head-mounted display which provides a composite space FK (for example, shown in FIG. 12) to a user, by superimposing a virtual space KK (for example, shown in FIG. 11) on a real space GK (for example, shown in FIG. 7).

Here, the “composite space” refers to a space formed by superimposing a moving image in a virtual space generated by computer processing on an object existing in a real space, which is a real world. In the following, for the convenience of the explanation, for example, an expression such as “display in a composite space by superimposing a real space and a virtual space” is used.

### Configuration of First Exemplary Embodiment

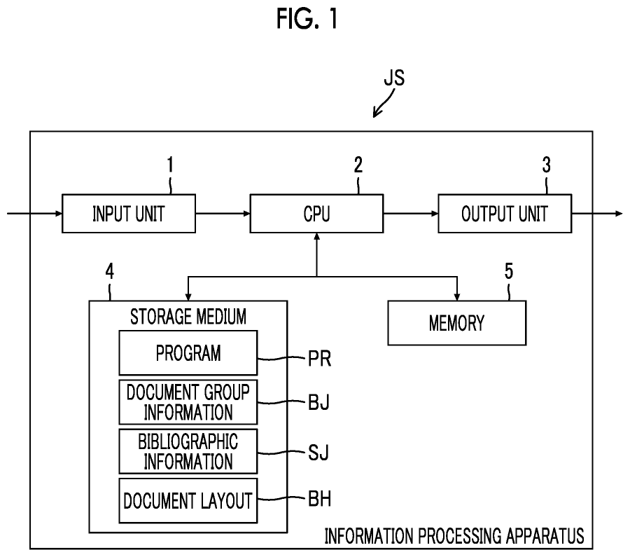

FIG. 1 shows a configuration of an information processing apparatus JS of a first exemplary embodiment. Hereinafter, the configuration of the information processing apparatus JS of the first exemplary embodiment will be described with reference to FIG. 1.

As shown in FIG. 1, the information processing apparatus JS of the first exemplary embodiment includes an input unit 1, a central processing unit (CPU) 2, an output unit 3, a storage medium 4, and a memory 5.

The input unit 1 is configured by, for example, a sensor, a camera, a keyboard, a mouse, and a touch panel. The CPU 2 is an example of a processor and is a core of a computer, that is well-known, and that operates hardware according to software. The output unit 3 is configured by, for example, a liquid crystal display and an organic electro luminescence (EL) display. The storage medium 4 is configured by, for example, a hard disk drive (HDD), a solid state drive (SSD), and a read only memory (ROM). The memory 5 is configured by, for example, a dynamic random access memory (DRAM) and a static random access memory (SRAM).

The storage medium 4 stores a program PR, document group information BJ, bibliographic information SJ, and a document layout BH.

The program PR is a group of instructions defining the content of processing to be executed by the CPU 2.

The document group information BJ, the bibliographic information SJ, and the document layout BH will be described later.

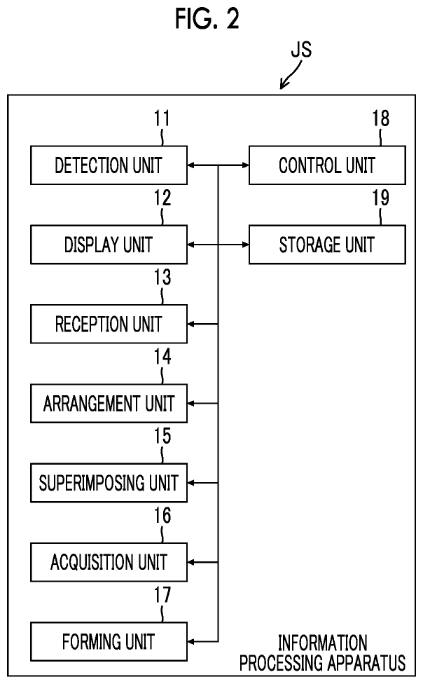

FIG. 2 is a functional block diagram of the information processing apparatus JS of the first exemplary embodiment.

As shown in FIG. 2, the information processing apparatus JS includes a detection unit 11, a display unit 12, a reception unit 13, an arrangement unit 14, a superimposing unit 15, an acquisition unit 16, a forming unit 17, a control unit 18, and a storage unit 19.

As for a relationship between the hardware configuration and the functional configuration in the information processing apparatus JS, on the hardware, the CPU 2 executes the program PR stored in the storage medium 4 (which realizes some functions of the storage unit 19) while using the memory 5 (which realizes some other functions of the storage unit 19), and controls the operations of the input unit 1 and the output unit 3, as the control unit 18, as needed, thereby realizing the functions of respective units of the detection unit 11, the display unit 12, the reception unit 13, the arrangement unit 14, the superimposing unit 15, the acquisition unit 16, and the forming unit 17. The functions of the respective units will be described later.

Document Group Information BJ

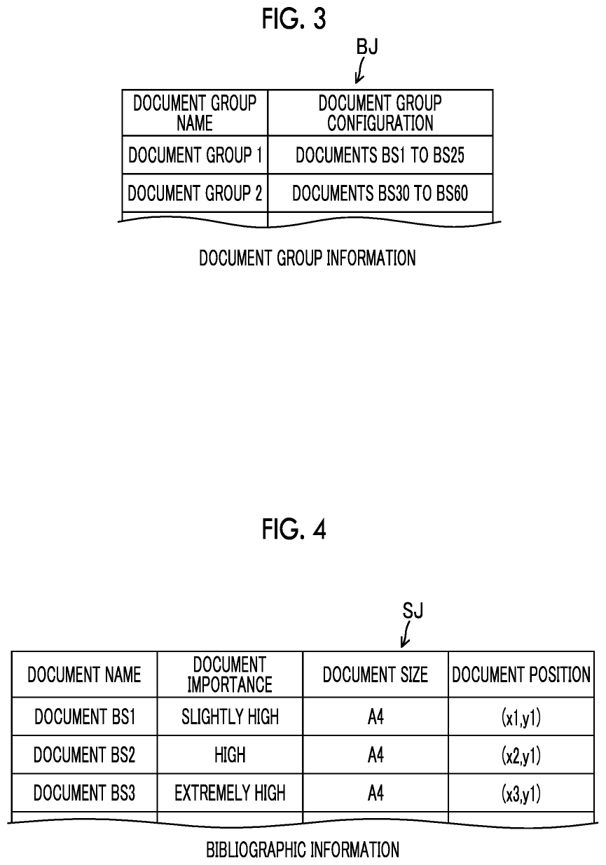

FIG. 3 shows the document group information BJ of the first exemplary embodiment.

The document group information BJ of the first exemplary embodiment shows a correspondence between a name of a document group and a plurality of documents forming the document group. As shown in FIG. 3, the document group information BJ includes a “document group name” and a “document group configuration”. More specifically, for example, a document group of which a name is “document group 1” (for example, a document group related to design and development) is composed of documents BS1 to BS25. Further, for example, a document group of which a name is “document group 2” (for example, a document group related to manufacturing) is composed of documents BS30 to BS60.

Bibliographic Information SJ

FIG. 4 shows the bibliographic information SJ of the first exemplary embodiment.

The bibliographic information SJ of the first exemplary embodiment shows bibliographic items of a document, for example, documents BS1, BS2, . . . (shown in FIG. 3). The bibliographic information SJ includes “document name”, “document importance”, “document size”, and “document position”, as shown in FIG. 4.

More specifically, for example, in a document of which a name is “document BS1”, the document importance is “slightly high”, the document size is “A4”, and the document position is (x1, y1). Further, for example, in a document of which a name is “document BS2”, the document importance is “high”, the document size is “A4”, and the document position is (x2, y1). Further, for example, in a document of which a name is “document BS3”, the document importance is “extremely high”, the document size is “A4”, and the document position is (x3, y1).

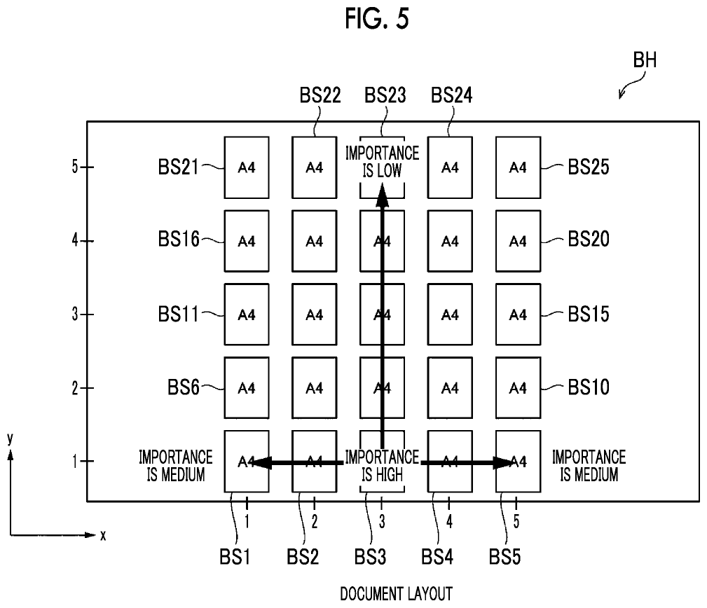

The “document position” is a position in the document layout BH (which will be described later with reference to FIG. 5).

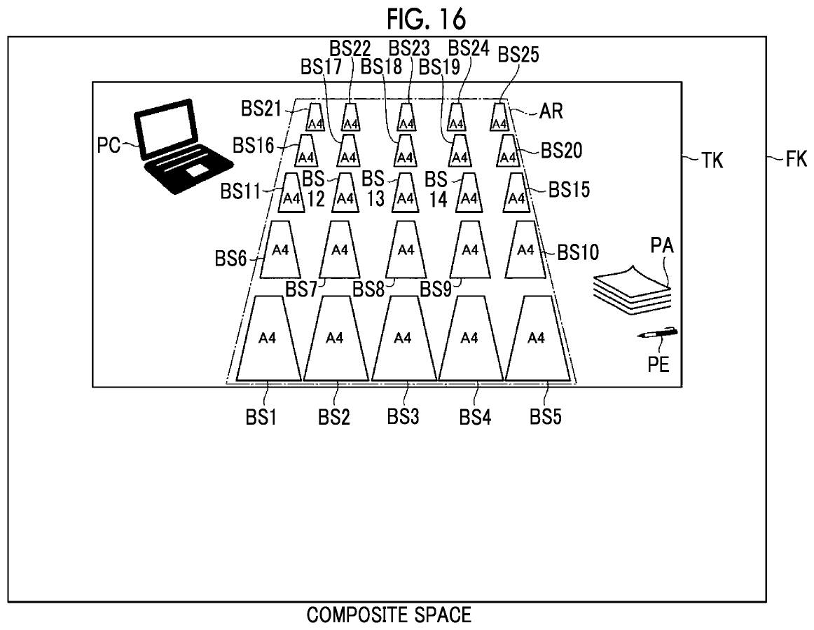

The “document position” is also a relative position in the free area AR. For example, in a wide free area AR (for example, shown in FIG. 11), the document BS1 is arranged in a lower left corner in the wide free area AR, and is arranged adjacent to the documents BS2, BS6, and BS7. On the other hand, even within a narrow free area AR (for example, shown in FIG. 16), the document BS1 is arranged in the lower left corner of the narrow free area AR and is arranged adjacent to the documents BS2, BS6, and BS7.

The “document position” is able to be freely arranged by the user, and the above-described “document importance” is determined by the position.

Document Layout BH

FIG. 5 shows the document layout BH of the first exemplary embodiment.

The document layout BH of the first exemplary embodiment shows an arrangement of the documents BS1, BS2, . . . (shown in FIG. 3). The document layout BH shows that, for example, the document BS1 is arranged at the position (x1, y1), the document BS2 is arranged at the position (x2, y1), and the document BS3 is arranged at the position (x3, y1).

Here, the “document importance” of the documents BS1, BS2, . . . is determined according to the document position indicated in the bibliographic information SJ of the documents BS1, BS2, . . . . Specifically, as for the documents BS1, BS2, . . . , the “document importance” is higher as the documents BS1, BS2, . . . are arranged on the positions closer to the user (where the value of the y-axis coordinate is small). More specifically, as for the documents BS1, BS2, . . . , the “document importance” “is higher as the documents BS1, BS2, . . . are arranged closer to the positions (x1, y1) to (x5, y1) in front of the user, and arranged closer to the central positions (x3, y1) to (x3, y5) with respect to the user.

### Operation of First Exemplary Embodiment

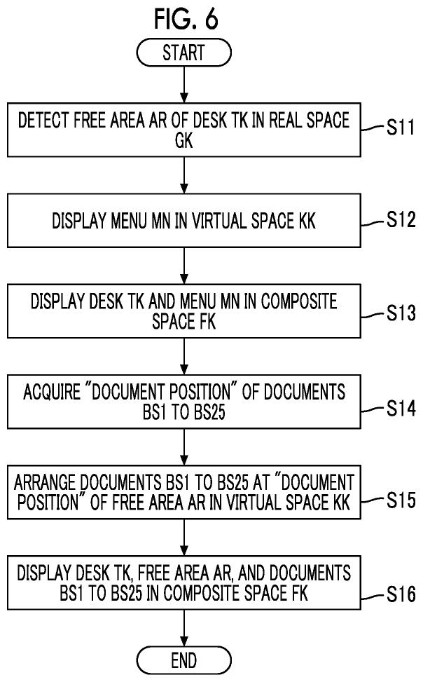

FIG. 6 is a flowchart showing the operation of the information processing apparatus JS of the first exemplary embodiment. Hereinafter, the operation of the information processing apparatus JS of the first exemplary embodiment will be described with reference to the flowchart of FIG. 6.

In the following, in order to facilitate the explanation and understanding, it is assumed that the composite space FK is generated by superimposing the virtual space KK in which the documents BS1 to BS25 configuring the document group 1 are arranged on the real space GK in which the desk TK exists. Here, the “desk TK” is an example of an “object in a real space”. Further, the “documents BS1, BS2, . . . ” are an example of “a plurality of virtual objects”. The “documents BS1, BS2, . . . ” are not limited to the papers and books that are paper media, for example, include compact discs (CDs) and digital Versatile Discs (DVDs) that are not paper media, and are not limited to one expressed in texts, and include, for example, one expressed in images and photographs other than texts.

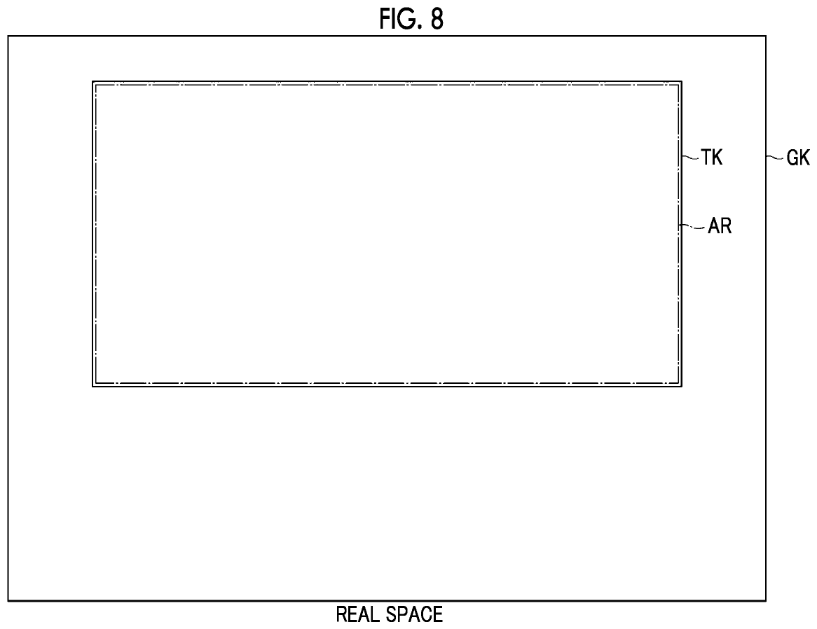

Step S11: in the information processing apparatus JS, the CPU 2 (shown in FIG. 1) detects, as the detection unit 11 (shown in FIG. 2), the desk TK in the real space GK as shown in FIG. 7, and, detect the free area AR of the desk TK as shown in FIG. 8.

Here, the CPU 2 performs detection of the desk TK and the free area AR by executing image processing, for example, regions with convolutional neural networks (R-CNN), you only look once (YOLO), single shot multibox detector (SSD), and the like which are well-known, on the image photographed by a camera, which is the input unit 1 (shown in FIG. 1).

Here, the “free area AR” refers to a range on the surface of the desk TK (for example, a top plate) where it is presumed that at least one of the documents B1, BS2, . . . are able to be placed.

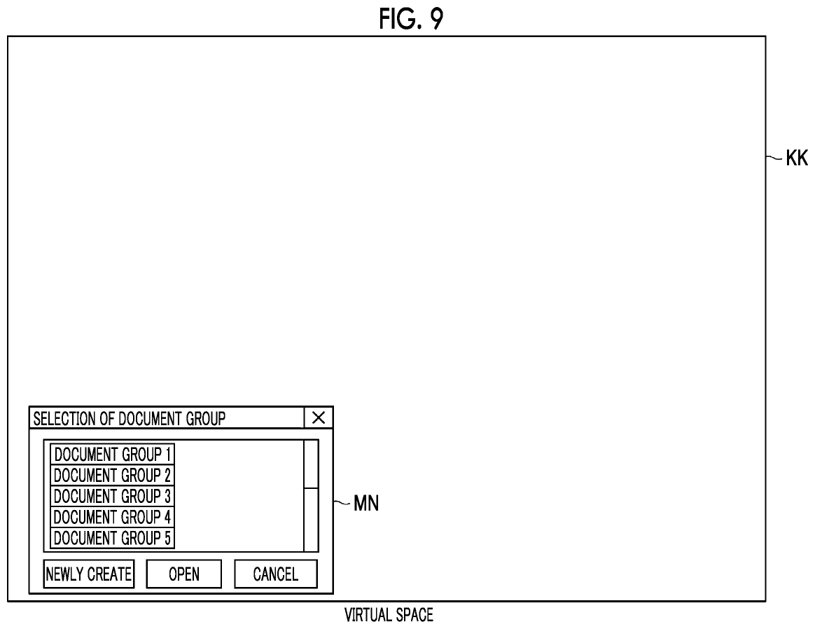

Step S12: the CPU 2 causes, as a display unit 12 (shown in FIG. 2), as shown in FIG. 9, a menu MN for allowing the user (not shown) to select the document group 1, the document group 2, . . . to be displayed in the virtual space KK.

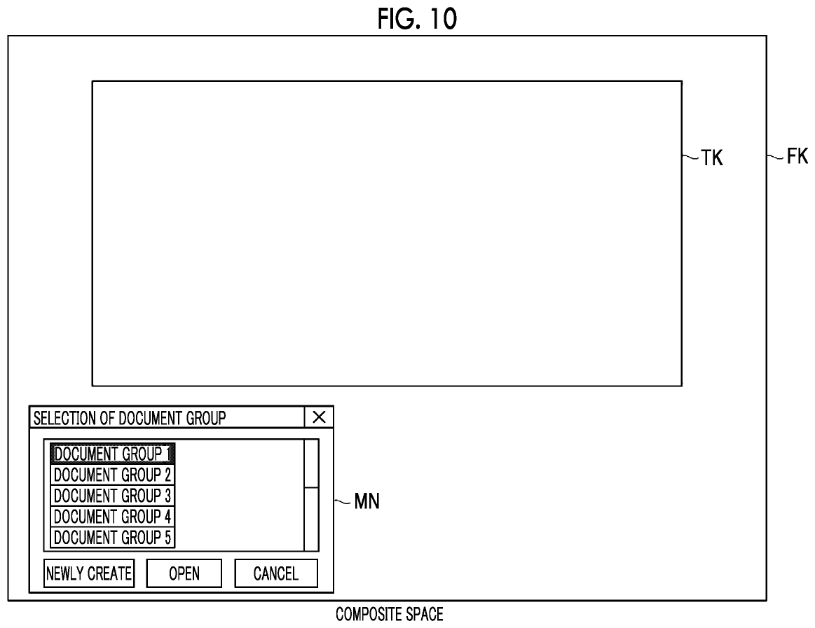

Step S13: the CPU 2 superimposes, as the superimposing unit 15 (shown in FIG. 2), the desk TK in the real space GK and the menu MN in the virtual space KK, to cause the desk TK and the menu MN to be displayed in the composite space FK, as the display unit 12 (shown in FIG. 2) as shown in FIG. 10. Here, it is assumed that the CPU 2 receives the selection of the “document group 1” from the user as the reception unit 13 (shown in FIG. 2).

Step S14: the CPU 2 acquires, as the acquisition unit 16 (shown in FIG. 2), as shown in FIG. 11, a fact that the “document group 1” is composed of the documents BS1 to BS25 (shown in FIG. 3) by referring to the document group information BJ (shown in FIG. 3) based on the “document group 1” selected in Step S13. The CPU 2 also acquires, as the acquisition unit, the “document position” of the documents BS1 to BS25 by referring to the bibliographic information SJ (shown in FIG. 4) and the document layout BH (shown in FIG. 5).

Step S15: the CPU 2 arranges, as the arrangement unit 14 (shown in FIG. 2), as shown in FIG. 11, in the virtual space KK, the documents BS1 to BS25 at the acquired “document position” of the documents BS1 to BS25 in the free area AR (shown in FIG. 8).

Step S16: the CPU 2 superimposes, as the superimposing unit 15 (shown in FIG. 2), the desk TK in the real space GK (shown in FIG. 8), and the free area AR and the documents BS1 to BS25 in the virtual space KK (shown in FIG. 11). As a result, the CPU 2 causes, as the display unit 12 (shown in FIG. 2), as shown in FIG. 12, the desk TK, the free area AR, and the documents BS1 to BS25 to be displayed in the composite space FK.

Here, as shown in FIG. 12, the CPU 2 causes the documents BS1, BS2, . . . to be enlarged and displayed as the “document position” (shown in FIG. 5) included in the document layout BH of the documents BS1, BS2, . . . is closer to the user.

Here, “closer to the user” means that, in a case where the user is in the center of the free area, the user is located in the center or in front of the free area. In this case, the document located in the center of the free area is displayed to be larger than the documents located on the left and right of the free area, and the document located in front of the user is displayed to be larger than the document located in the interior to the user.

The free area AR (shown in FIG. 12) in the composite space FK may or may not be visible to the user.

### Second Exemplary Embodiment

An information processing apparatus JS of a second exemplary embodiment will be described.

### Configuration of Second Exemplary Embodiment

The information processing apparatus JS of the second exemplary embodiment has the same configuration and functions as the configuration (shown in FIG. 1) and functions (shown in FIG. 2) of the information processing apparatus JS of the first exemplary embodiment.

### Operation of Second Exemplary Embodiment

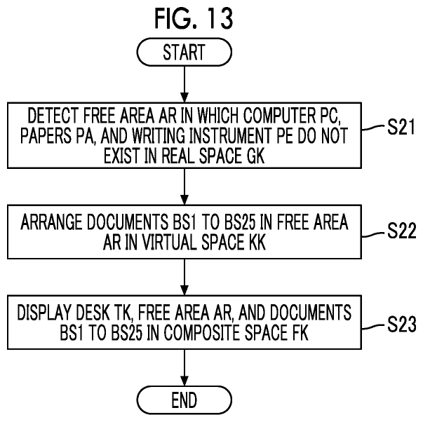

FIG. 13 is a flowchart showing an operation of the information processing apparatus JS of the second exemplary embodiment. Hereinafter, the operation of the information processing apparatus JS of the second exemplary embodiment will be described with reference to the flowchart of FIG. 13.

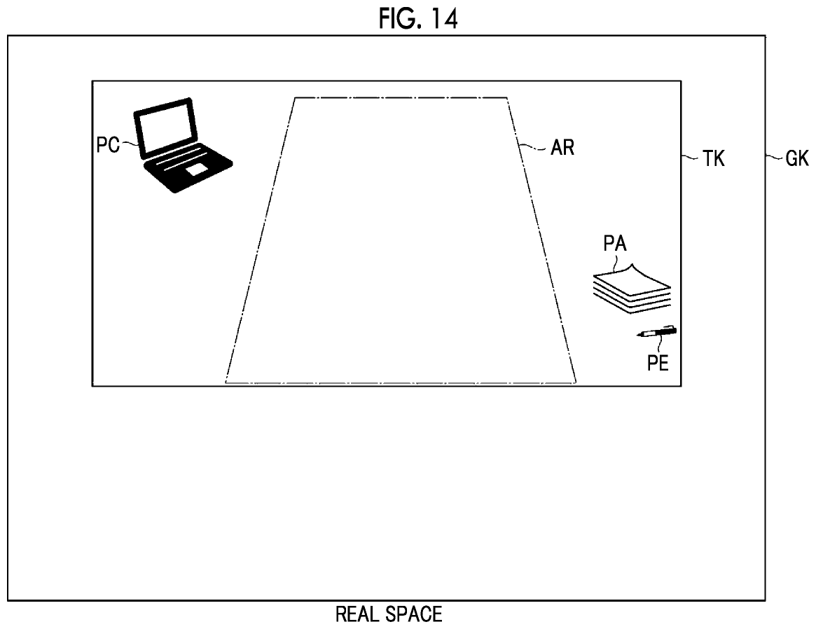

In the second exemplary embodiment, unlike the first exemplary embodiment in which nothing exists on the desk TK in the real space GK, as shown in FIG. 14, a computer PC, papers PA, and a writing instrument PE exist.

Here, the computer PC, the papers PA, and the writing instrument PE are examples of “obstacle”, respectively.

In the following, in order to simplify the explanation, it is assumed that the user has selected the document group 1, that is, the documents BS1 to BS25 in advance.

Step S21: in the information processing apparatus JS, the CPU 2 (shown in FIG. 1) detects, as the detection unit 11 (shown in FIG. 2), as shown in FIG. 14, the desk TK in the real space GK, and the free area AR in which the computer PC, the papers PA, and the writing instrument PE do not exist.

Here, the CPU 2 detects the free area AR in which the computer PC, the papers PA, and the writing instrument PE do not exist as follows. The CPU 2 detects the presence of the desk TK, the computer PC, the papers PA, and the writing instrument PE by using the well-known image processing such as R-CNN described in the first exemplary embodiment. After the detection, the CPU 2 subtracts the area where the computer PC, the papers PA, and the writing instrument PE exist from the surface of the desk TK, for example, the area of the top plate. As a result, the CPU 2 acquires the free area AR in which the computer PC, the papers PA, and the writing instrument PE do not exist.

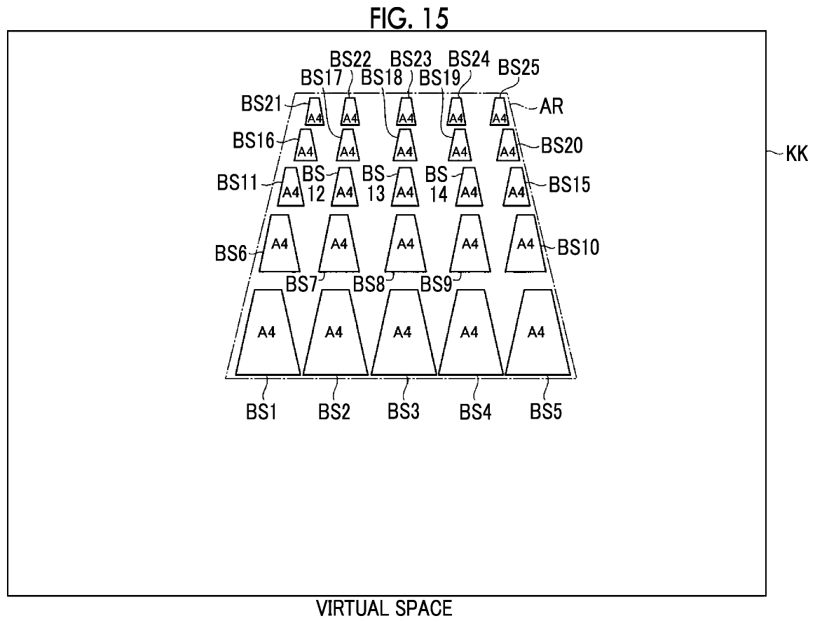

Step S22: the CPU 2 arranges, as the arrangement unit 14 (shown in FIG. 2), as shown in FIG. 15, the documents BS1 to BS25 (shown in FIG. 3) configuring the “document group 1” in the free area AR in the virtual space KK.

Step S23: the CPU 2 superimposes, as the superimposing unit 15 (shown in FIG. 2), the desk TK in the real space GK (shown in FIG. 8), and the free area AR and the documents BS1 to BS25 in the virtual space KK (shown in FIG. 15). As a result, the CPU 2 causes, as the display unit 12 (shown in FIG. 2), as shown in FIG. 16, the desk TK, the free area AR, and the documents BS1 to BS25 to be displayed in the composite space FK.

Note that, the shape of the free area does not have to be rectangular and the free area may be an area where the obstacles are excluded. Therefore, the shape of the free area may be a polygon, a circle, an ellipse, or the like.

### Modification of Second Exemplary Embodiment

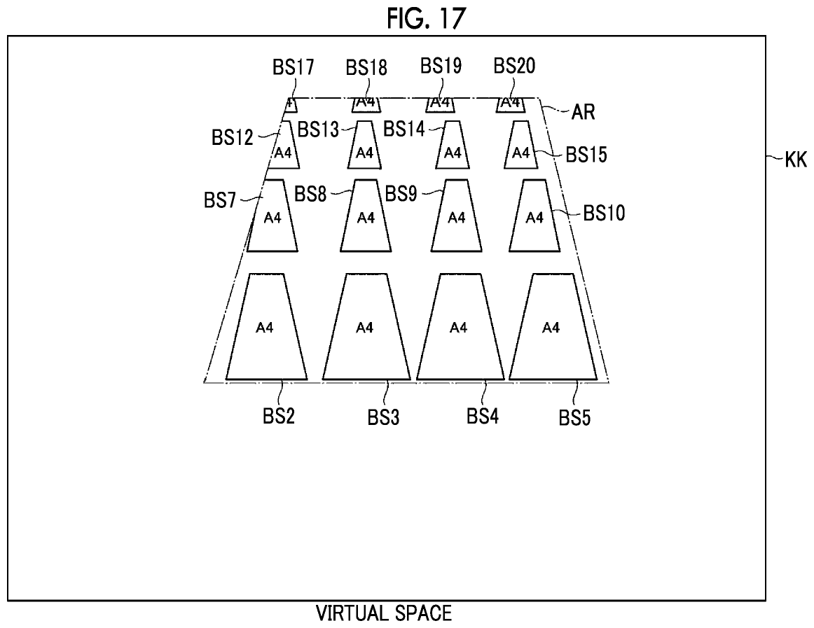

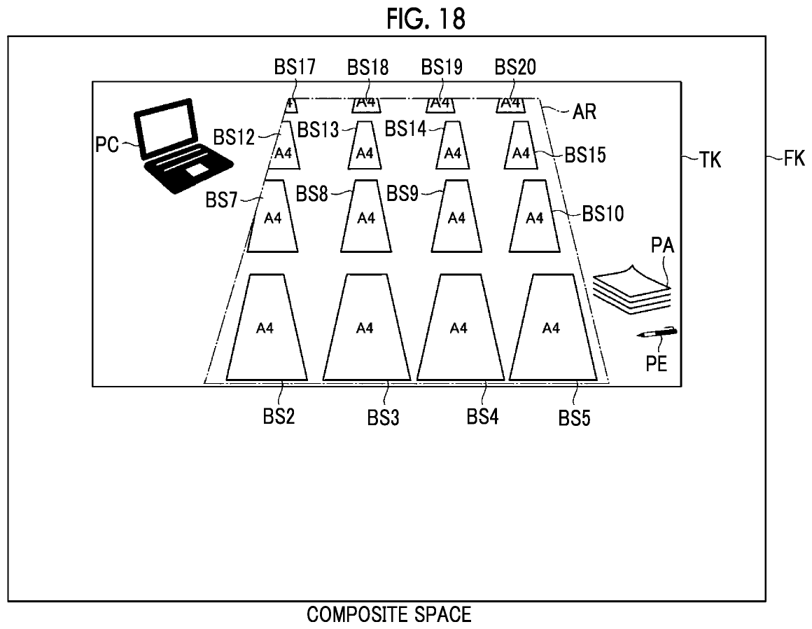

In place of Steps S22 and S23 described above, the CPU 2 enlarges and arranges, as the arrangement unit 14, as shown in FIG. 17, in the virtual space KK, a portion of the documents BS1 to BS25, for example, the documents BS2 to BS5, BS7 to BS10, BS12 to BS15, and BS17 to BS20 according to, for example, an operation by the user. As a result, the CPU 2 may cause, as the display unit 12, the desk TK, the free area AR, the enlarged documents BS2 to BS5, BS7 to BS10, BS12 to BS15, and BS17 to BS20 to be displayed in the composite space FK as shown in FIG. 18.

### Third Exemplary Embodiment

An information processing apparatus JS of a third exemplary embodiment will be described.

### Configuration of Third Exemplary Embodiment

The information processing apparatus JS of the third exemplary embodiment has the same configuration and functions as the configuration (shown in FIG. 1) and functions (shown in FIG. 2) of the information processing apparatus JS of the first exemplary embodiment.

### Operation of Third Exemplary Embodiment

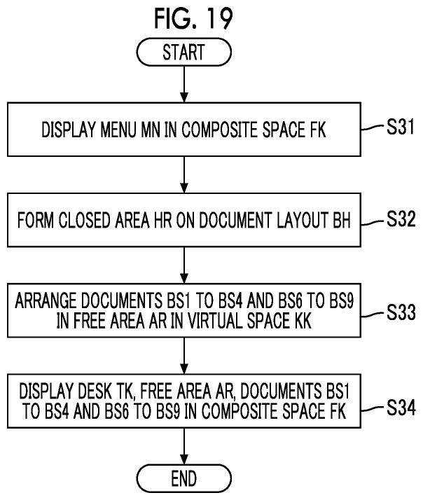

FIG. 19 is a flowchart showing an operation of an information processing apparatus JS of a third exemplary embodiment. Hereinafter, the operation of the information processing apparatus JS of the third exemplary embodiment will be described with reference to the flowchart of FIG. 19.

In the third exemplary embodiment, unlike the first exemplary embodiment in which all of the documents BS1 to BS25 are displayed, a portion of the documents among the documents BS1 to BS25 selected by the user are displayed.

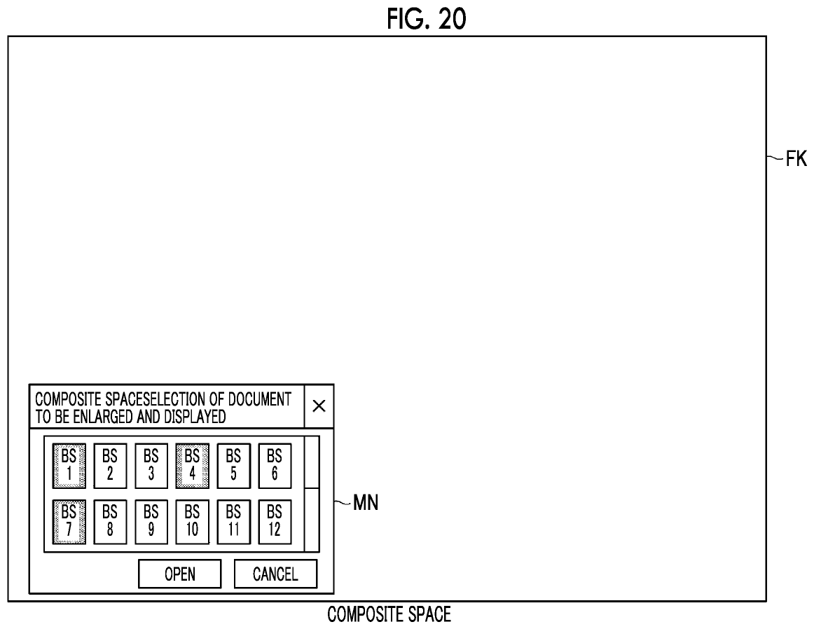

Step S31: in the information processing apparatus JS, the CPU 2 (shown in FIG. 1) displays, as the display unit 12 (shown in FIG. 2), the menu MN in the composite space FK as shown in FIG. 20. As shown in FIG. 20, the menu MN allows the user to select a document required to be displayed from among the documents BS1 to BS25. Here, it is assumed that the CPU 2 receives, as the reception unit 13 (shown in FIG. 2), the selection of the documents BS1, BS4, and BS7 from the user.

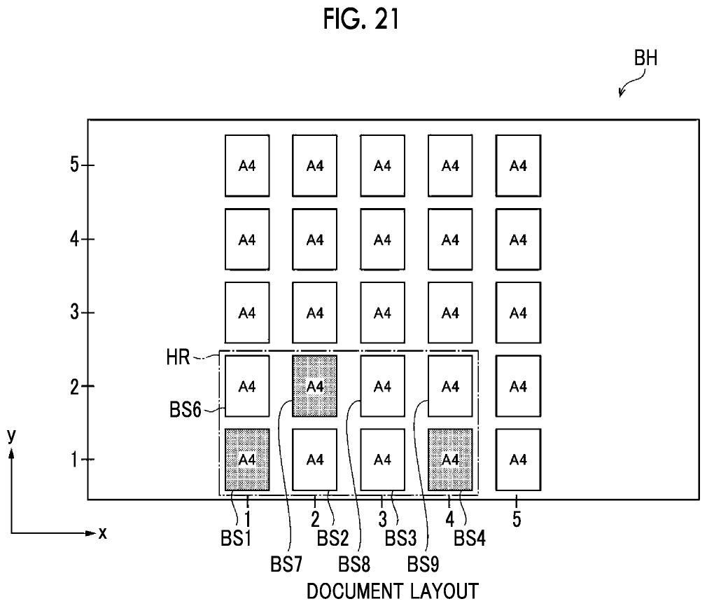

Step S32: the CPU 2 forms, as the forming unit 17 (shown in FIG. 2), a closed area HR specified by the documents BS1, BS4, and BS7 selected in Step S31 on the document layout BH as shown in FIG. 21. Here, as shown in FIG. 21, the documents BS1 to BS4 and BS6 to BS9 exist in the closed area HR.

Here, the “closed area” is, more specifically, a rectangular area including all of the selected documents BS1, BS4, and BS7, which has the minimum required area.

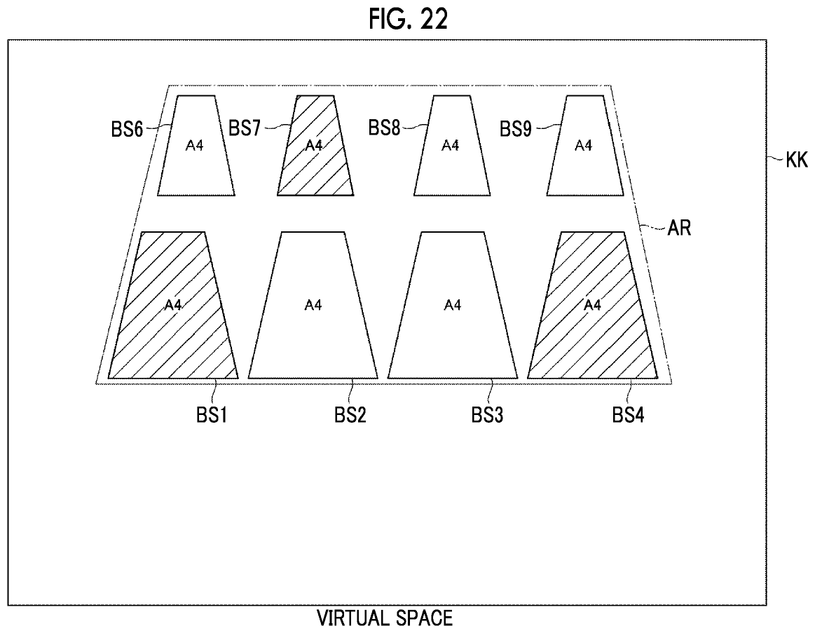

Step S33: the CPU 2 arranges, as the arrangement unit 14 (shown in FIG. 2), in the virtual space KK, the documents BS1 to BS4 and BS6 to BS9 existing in the closed area HR (shown in FIG. 21) in the free area AR of the desk TK as shown in FIG. 22.

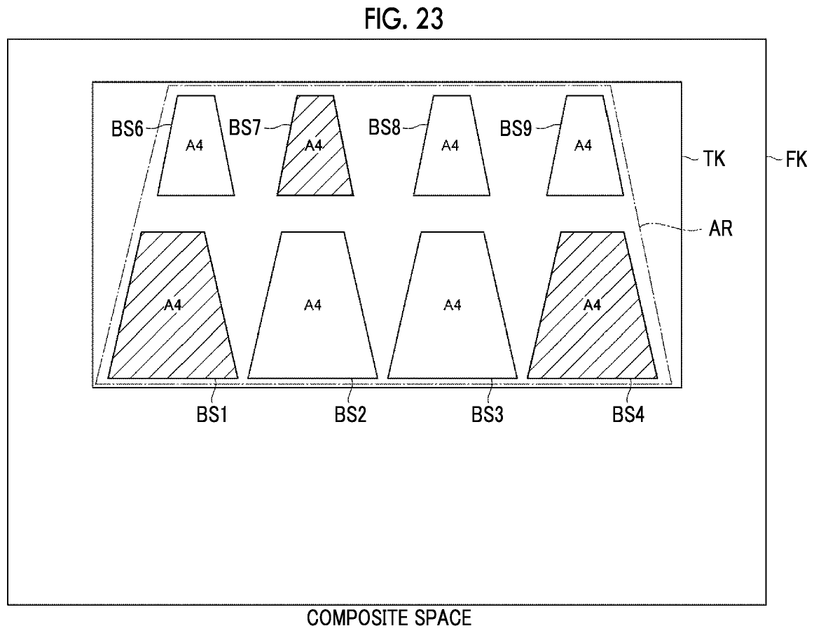

Step S34: the CPU 2 superimposes, as the superimposing unit 15 (shown in FIG. 2), the desk TK in the real space GK (shown in FIG. 8), and the free area AR and the documents BS1 to BS4 and BS6 to BS9 in the virtual space KK (shown in FIG. 22). As a result, the CPU 2 causes, as the display unit 12 (shown in FIG. 2), the desk TK, the free area AR, and the documents BS1 to BS4 and BS6 to BS9 to be displayed in the composite space FK as shown in FIG. 23.

Here, the CPU 2 does not need to display all of the documents BS1 to BS25 in the free area AR. As a result, the CPU 2 enlarges and displays the documents BS1 to BS4 and BS6 to BS9, for example, by comparing with the size of the documents BS1 to BS25 (shown in FIG. 12) in the composite space FK of the first exemplary embodiment.

### Fourth Exemplary Embodiment

An information processing apparatus JS of a fourth exemplary embodiment will be described.

### Configuration of Fourth Exemplary Embodiment

The information processing apparatus JS of the fourth exemplary embodiment has the same configuration and functions as the configuration (shown in FIG. 1) and functions (shown in FIG. 2) of the information processing apparatus JS of the first exemplary embodiment.

### Operation of Fourth Exemplary Embodiment

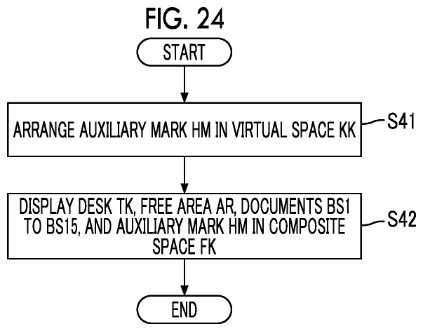

FIG. 24 is a flowchart showing an operation of an information processing apparatus JS of a fourth exemplary embodiment. Hereinafter, the operation of the information processing apparatus JS of the fourth exemplary embodiment will be described with reference to the flowchart of FIG. 24.

In the fourth exemplary embodiment, unlike the first exemplary embodiment, an auxiliary mark for assisting the visual recognition of the documents BS1 to BS25 is displayed in perspective.

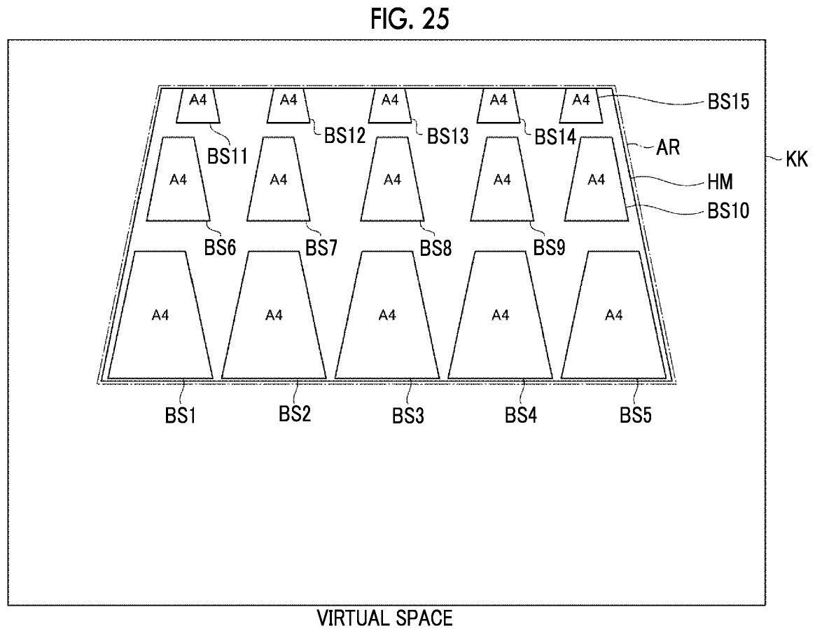

Step S41: in the information processing apparatus JS, the CPU 2 (shown in FIG. 1) additionally arranges, as the display unit 12 (shown in FIG. 2), as shown in FIG. 25, for example, the auxiliary mark HM that visualizes the range of the free area AR in which the documents BS1 to BS15 are enlarged and arranged. Since the documents BS1 to BS15 are displayed based on perspective, the free area in which the documents BS1 to BS15 are arranged is also deformed into a trapezoidal shape based on perspective. By visualizing the range in which the documents BS1 to BS15 are arranged, the user may recognize in which range the documents BS1 to BS15 are able to be handled.

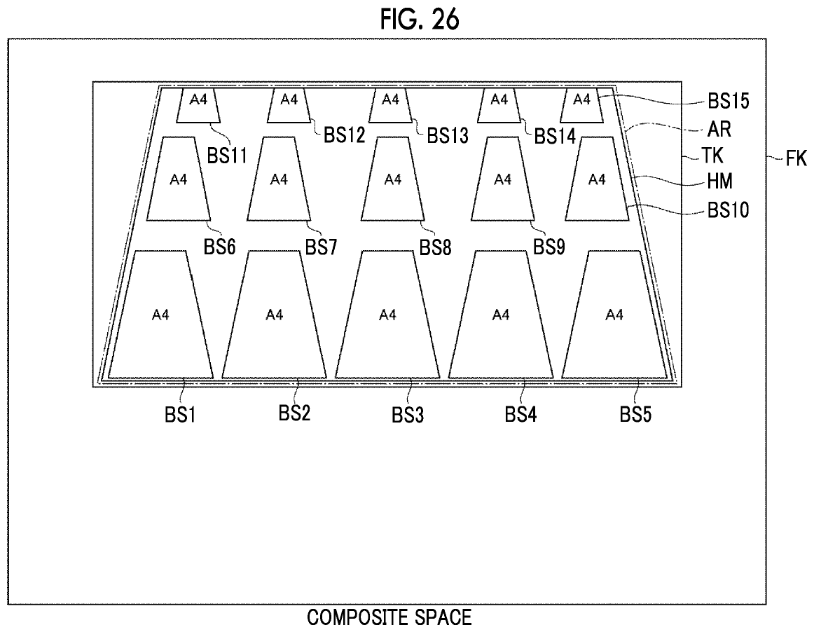

Step S42: the CPU 2 superimposes, as the superimposing unit 15 (shown in FIG. 2), the desk TK in the real space GK (shown in FIG. 8), and the free area AR, the documents BS1 to BS15, and the auxiliary mark HM in the virtual space KK (shown in FIG. 25). As a result, the CPU 2 causes, as the display unit 12 (shown in FIG. 2), the desk TK, the free area AR, the documents BS1 to BS15, and the auxiliary mark HM to be displayed in the composite space FK as shown in FIG. 26.

### Fifth Exemplary Embodiment

An information processing apparatus JS of a fifth exemplary embodiment will be described.

### Configuration of Fifth Exemplary Embodiment

The information processing apparatus JS of the fifth exemplary embodiment has the same configuration and functions as the configuration (shown in FIG. 1) and functions (shown in FIG. 2) of the information processing apparatus JS of the first exemplary embodiment.

### Operation of Fifth Exemplary Embodiment

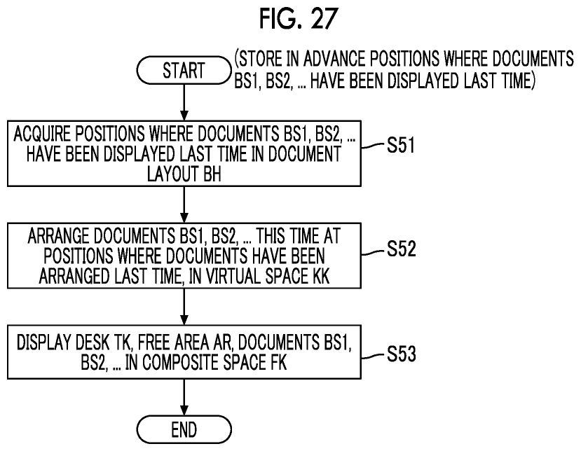

FIG. 27 is a flowchart showing an operation of an information processing apparatus JS of a fifth exemplary embodiment. Hereinafter, the operation of the information processing apparatus JS of the fifth exemplary embodiment will be described with reference to the flowchart of FIG. 27.

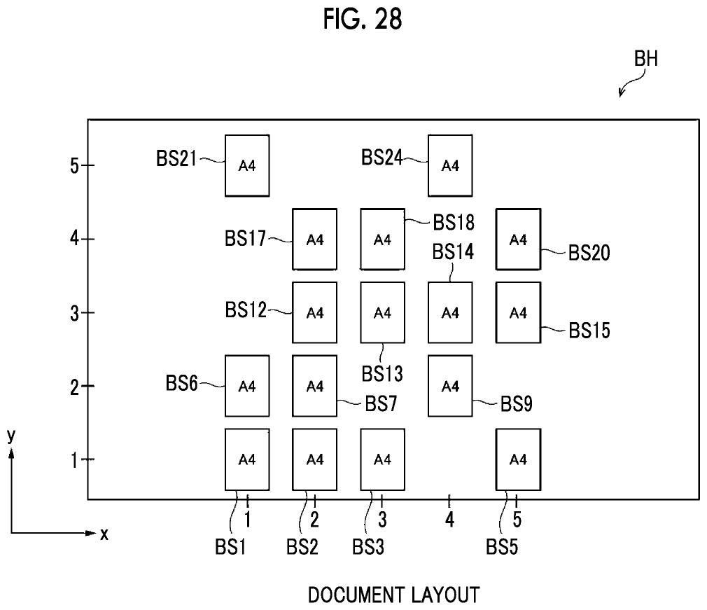

In the fifth exemplary embodiment, it is assumed that the positions where the documents BS1, BS2, . . . have been displayed last time prior to this time are stored in the document layout BH (shown in FIG. 28).

Here, as shown in the document layout BH shown in FIG. 28, last time, for example, the documents BS4, BS8, BS10, . . . have not been existed, that is, it is a state in which the document BS4 and the like are omitted.

Step S51: in the information processing apparatus JS, the CPU 2 (shown in FIG. 1) acquires, as the acquisition unit 16 (shown in FIG. 2), the positions where the documents BS1, BS2, . . . should be arranged this time by referring to the document layout BH showing the positions where the documents BS1, BS2, . . . have been displayed last time as shown in FIG. 28.

More specifically, as shown in FIG. 28, the CPU 2 acquires the positions where the documents BS1, BS2, BS3, BS5, BS6, BS7, and BS9, . . . , among the documents BS1 to BS25, which are the documents that have been existed last time, are arranged.

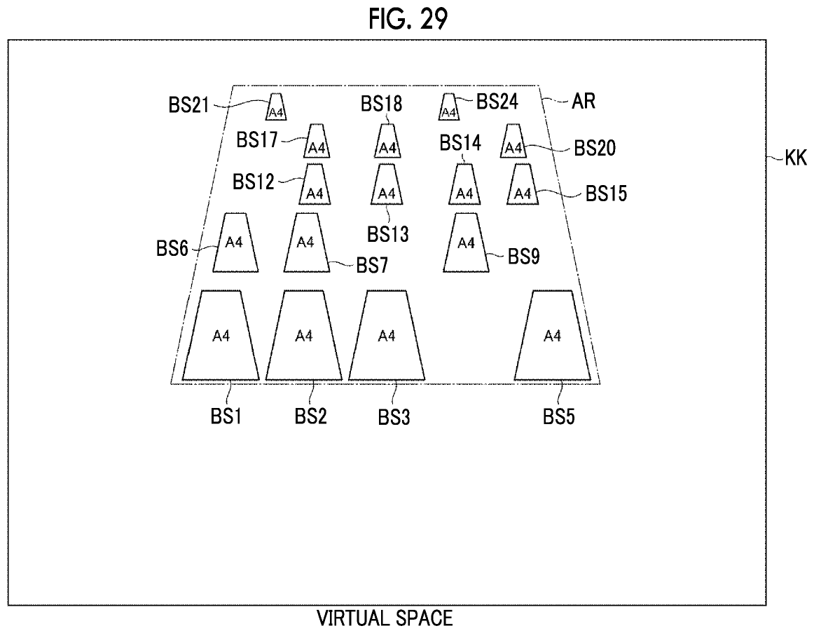

Step S52: the CPU 2 arranges, as the arrangement unit 14 (shown in FIG. 2), as shown in FIG. 29, the documents BS1, BS2, BS3, BS5, BS6, BS7, BS9, . . . this time at the positions where the documents BS1, BS2, BS3, BS5, BS6, BS7, BS9, . . . have been arranged last time, in the free area AR of the virtual space KK.

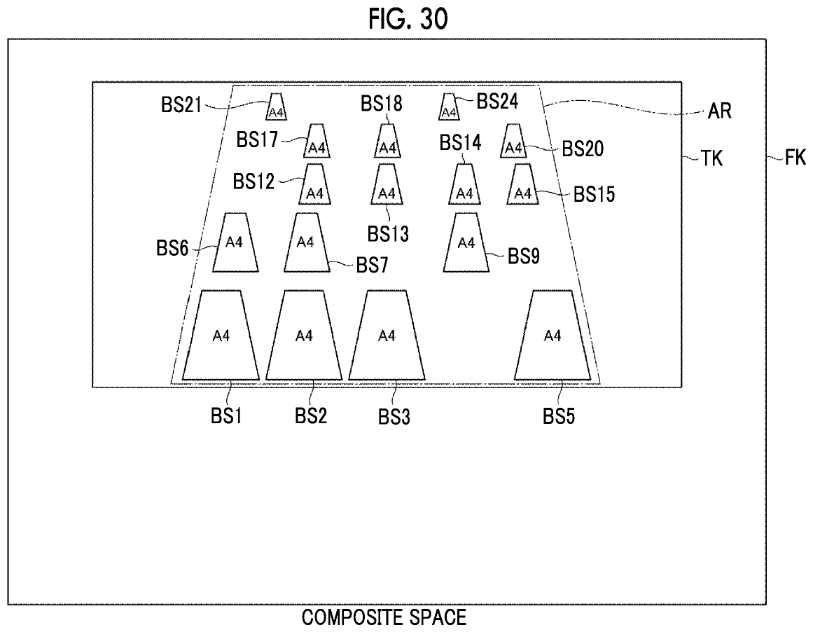

Step S53: the CPU 2 superimposes, as the superimposing unit 15 (shown in FIG. 2), the desk TK in the real space GK (shown in FIG. 8), and the free area AR and the documents BS1, BS2, . . . in the virtual space KK (shown in FIG. 29). As a result, the CPU 2 causes, as the display unit 12, as shown in FIG. 30, the desk TK, the free area AR, and the documents BS1, BS2, . . . to be displayed in the composite space FK.

### Sixth Exemplary Embodiment

An information processing apparatus JS of a sixth exemplary embodiment will be described.

### Configuration of Sixth Exemplary Embodiment

The information processing apparatus JS of the sixth exemplary embodiment has the same configuration and functions as the configuration (shown in FIG. 1) and functions (shown in FIG. 2) of the information processing apparatus JS of the first exemplary embodiment.

### Operation of Sixth Exemplary Embodiment

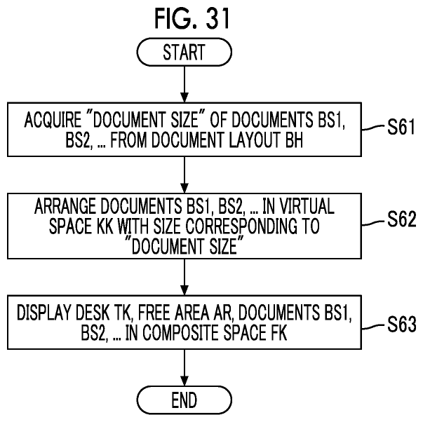

FIG. 31 is a flowchart showing an operation of an information processing apparatus JS of a sixth exemplary embodiment. Hereinafter, the operation of the information processing apparatus JS of the sixth exemplary embodiment will be described with reference to the flowchart of FIG. 31.

In the sixth exemplary embodiment, unlike the first exemplary embodiment, the documents BS1, BS2, . . . are displayed in a size corresponding to the “document size” which is the bibliographic information SJ of the documents BS1, BS2, . . . .

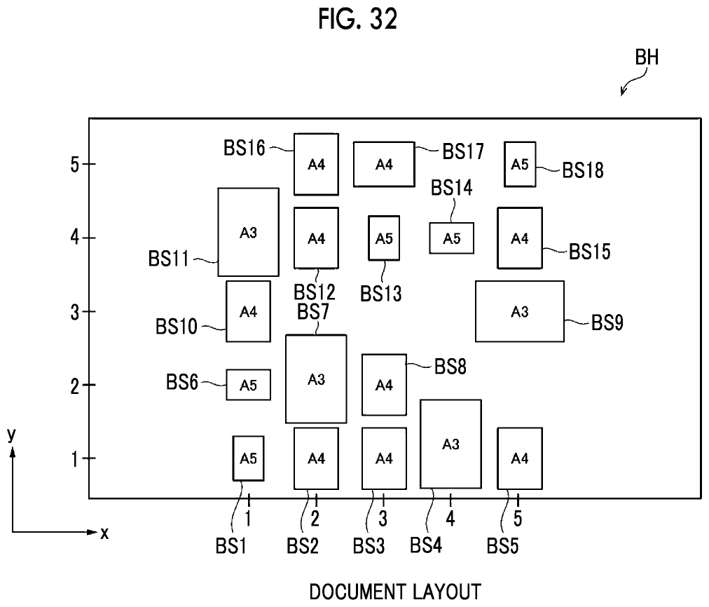

In the following, in order to facilitate the explanation and understanding, as shown in FIG. 32, it is assumed that the “document size” (shown in FIG. 4) included in the bibliographic information SJ of the documents BS1, BS2, . . . is also included in the document layout BH. Here, as shown in FIG. 32, “A3”, “A4”, and “A5” correspond to “document size”.

Step S61: in the information processing apparatus JS, the CPU 2 (shown in FIG. 1) acquires, as the acquisition unit 16 (shown in FIG. 2), the “document size” of the documents BS1, BS2, . . . from the document layout BH (shown in FIG. 32).

The CPU 2 acquires, for example, the fact that the document size of the document BS1 is “A5” and the document size of the document BS2 is “A4”.

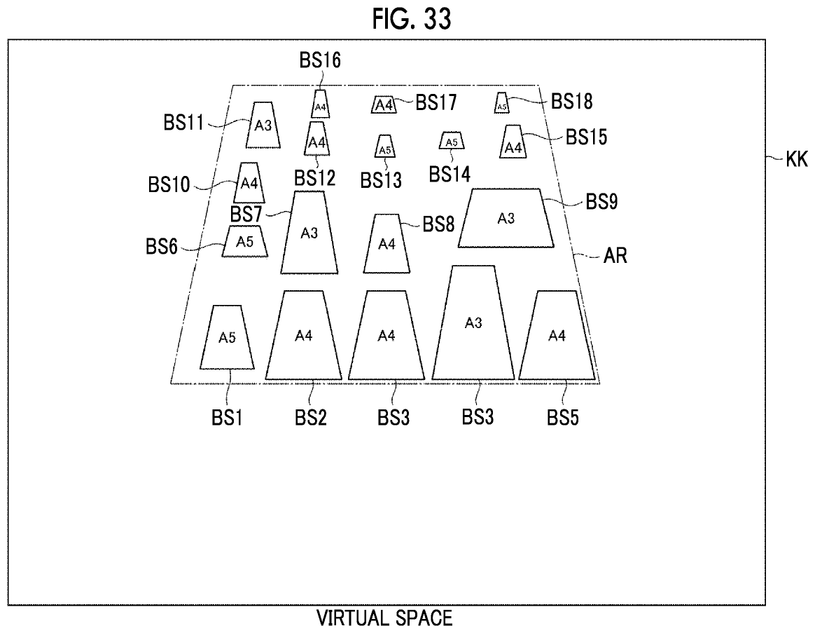

Step S62: the CPU 2 arranges, as the arrangement unit 14 (shown in FIG. 2), as shown in FIG. 33, in the virtual space KK, the documents BS1, BS2, . . . in the free area AR with the size corresponding to the “document size” of the documents BS1, BS2, . . . .

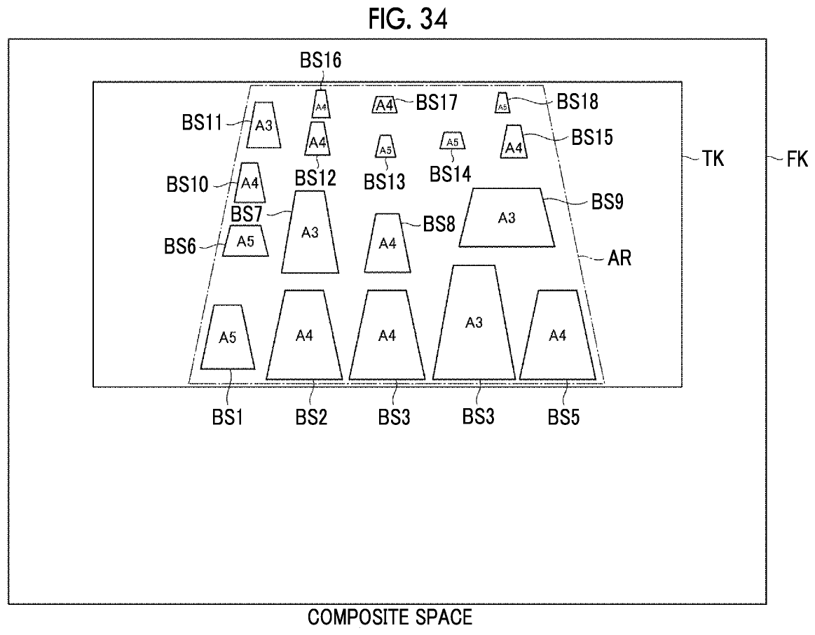

Step S63: the CPU 2 superimposes, as the superimposing unit 15 (shown in FIG. 2), the desk TK in the real space GK (shown in FIG. 8), and the free area AR and the documents BS1, BS2, . . . in the virtual space KK (shown in FIG. 33). As a result, the CPU 2 causes, as the display unit 12 (shown in FIG. 2), the desk TK, the free area AR, and the documents BS1, BS2, . . . to be displayed in the composite space FK as shown in FIG. 34.

### Seventh Exemplary Embodiment

An information processing apparatus JS of a seventh exemplary embodiment will be described.

### Configuration of Seventh Exemplary Embodiment

The information processing apparatus JS of the seventh exemplary embodiment has the same configuration and functions as the configuration (shown in FIG. 1) and functions (shown in FIG. 2) of the information processing apparatus JS of the first exemplary embodiment.

### Operation of Seventh Exemplary Embodiment

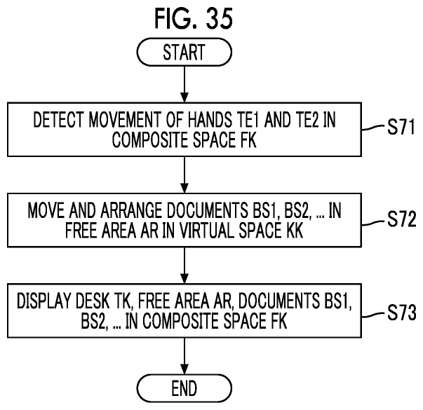

FIG. 35 is a flowchart showing an operation of an information processing apparatus JS according to a seventh exemplary embodiment. Hereinafter, the operation of the information processing apparatus JS according to the seventh exemplary embodiment will be described with reference to the flowchart of FIG. 35.

In the seventh exemplary embodiment 7, unlike the first exemplary embodiment in which the positions of the documents BS1, BS2, . . . are fixed, the positions of the documents BS1, BS2, . . . are changed in response to the user's operation.

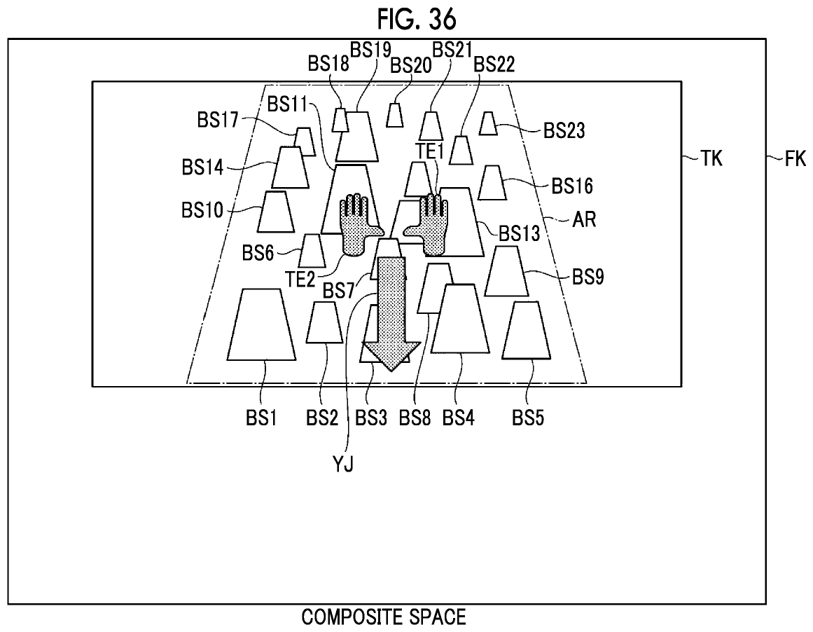

In the following, in order to facilitate the explanation and understanding, as shown in FIG. 36, it is assumed that the documents BS1, BS2, . . . are displayed in advance in the free area AR of the desk TK in the composite space FK.

Step S71: in the information processing apparatus JS, the CPU 2 (shown in FIG. 1) detects, as the detection unit 11 (shown in FIG. 2), as shown by the arrow YJ in FIG. 36, a movement instruction to move the documents BS1, BS2, . . . in the direction of the front of the user in the free area AR by the user's hands TE1 and TE2.

Here, the CPU 2 detects the movement of the user's hands TE1 and TE2 by performing well-known image processing, for example, a matching method, a gradient method, or the like on an image photographed by a camera, which is an input unit 1 (shown in FIG. 1).

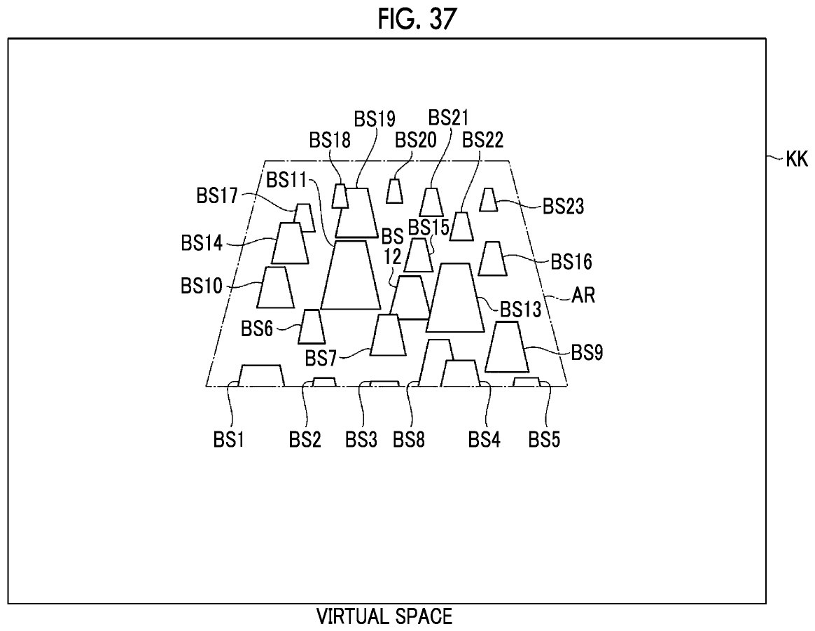

Step S72: the CPU 2 moves and arranges, as the arrangement unit 14 (shown in FIG. 2), as shown in FIG. 37, in the virtual space KK, all of the documents BS1, BS2, . . . in the free area AR at positions corresponding to the length (distance moved by the hands TE1 and TE2) of the arrow YJ in FIG. 36.

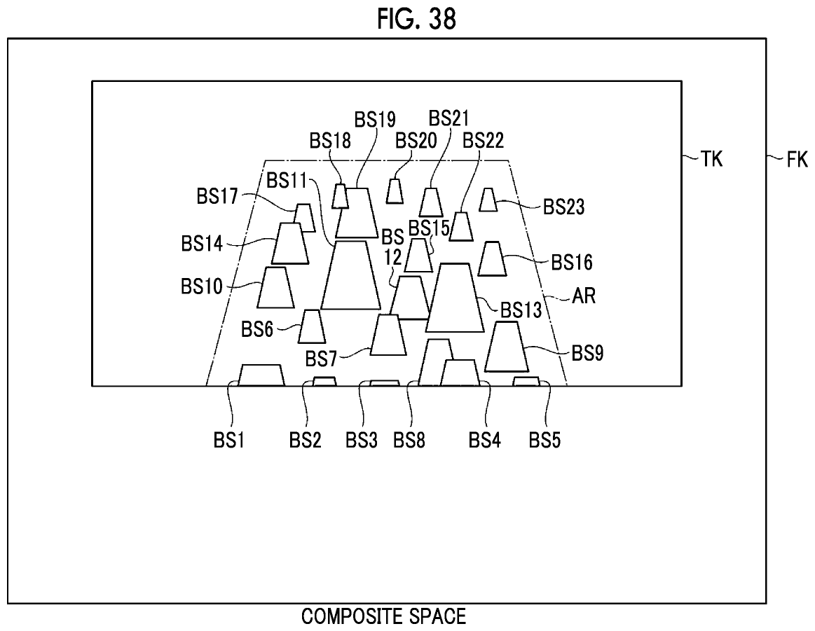

Step S73: the CPU 2 superimposes, as the superimposing unit 15 (shown in FIG. 2), the desk TK in the real space GK (shown in FIG. 8), and the free area AR and the documents BS1, BS2, . . . in the virtual space KK (shown in FIG. 37). As a result, the CPU 2 causes, as the display unit 12 (shown in FIG. 2), all of the desk TK, the free area AR, and the documents BS1, BS2, . . . to be displayed in the composite space FK as shown in FIG. 38.

In contrast to Steps S71 to 73 described above, the CPU 2 may cause, when a movement instruction to move the documents BS1, BS2, . . . in a direction opposite to the direction of the front of the user (direction away from the user) in the free area AR by the user's hands TE1 and TE2 is detected, all of the documents BS1, BS2, . . . to be displayed after moving and arranging all of the documents BS1, BS2, . . . in the opposite direction.

Note that, when any of the documents BS1, BS2, . . . , for example, the document BS1 is located outside the free area AR due to the above-described movement in the direction of the front of the user and a movement away from the user, the document BS1 may not be displayed.

### Eighth Exemplary Embodiment

An information processing apparatus JS of an eighth exemplary embodiment will be described.

### Configuration of Eighth Exemplary Embodiment

The information processing apparatus JS of the eighth exemplary embodiment has the same configuration and functions as the configuration (shown in FIG. 1) and functions (shown in FIG. 2) of the information processing apparatus JS of the first exemplary embodiment.

### Operation of Eighth Exemplary Embodiment

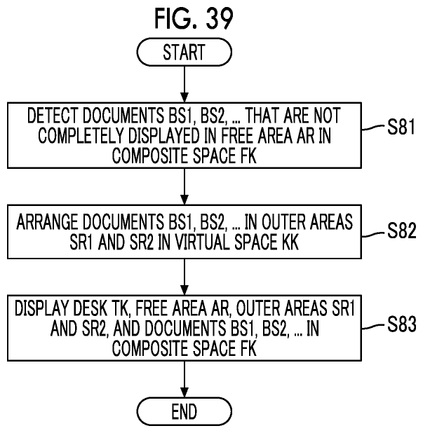

FIG. 39 is a flowchart showing an operation of an information processing apparatus JS of an eighth exemplary embodiment. Hereinafter, the operation of the information processing apparatus JS of the eighth exemplary embodiment will be described with reference to the flowchart of FIG. 39.

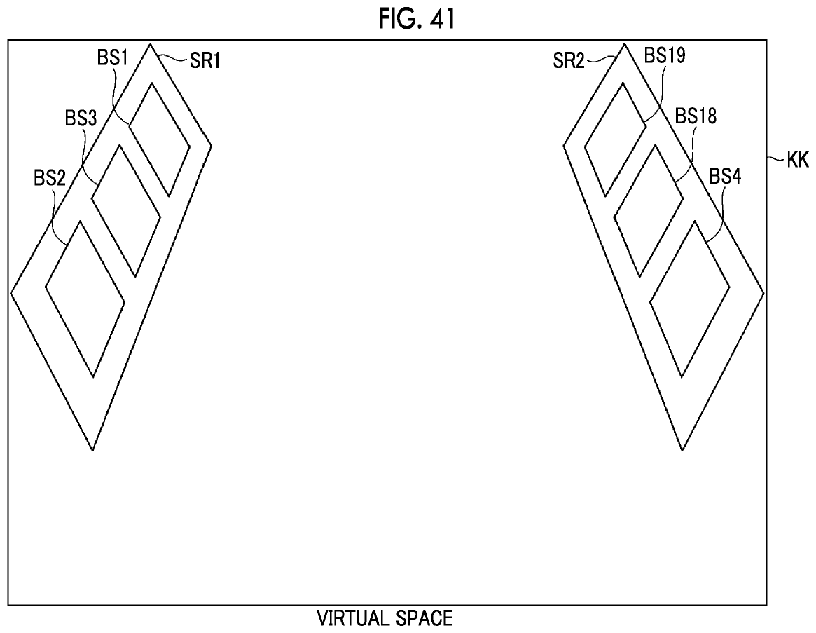

In the eighth exemplary embodiment, unlike the first exemplary embodiment in which the documents BS1, BS2, . . . are arranged and displayed in the free area AR, the documents BS1, BS2, . . . are arranged and displayed not only in the free area AR but also in the outer areas SR1 and SR2 (for example, shown in FIG. 41) located outside the free area AR.

In the following, in order to facilitate the explanation and understanding, it is assumed that, in the composite space FK, for example, the documents BS1, BS2, . . . which are a portion of the documents BS1 to BS25, are arranged in advance in the free area AR in response to the operation (for example, the enlargement of the document or the movement of the document) of the document by the user.

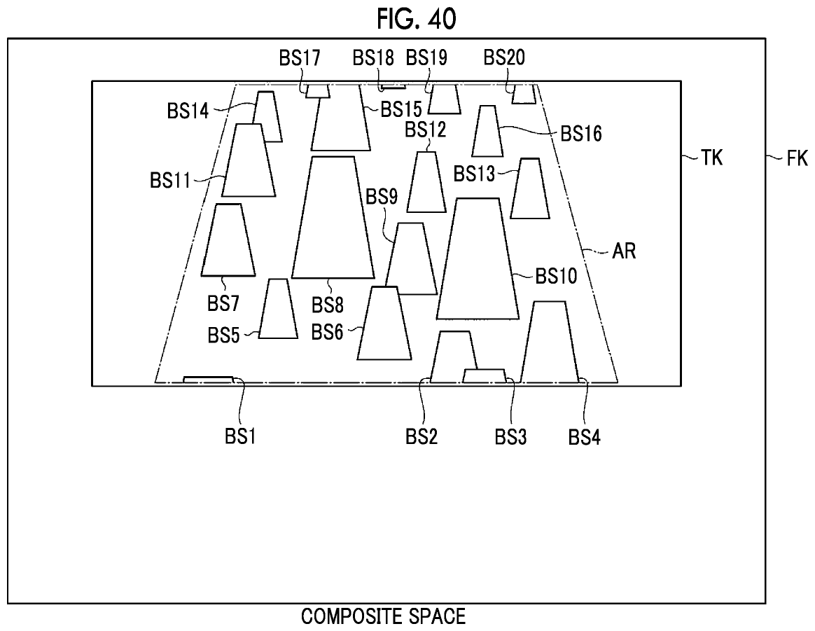

Step S81: in the information processing apparatus JS, the CPU 2 (shown in FIG. 1) detects, as the detection unit 11 (shown in FIG. 2), as shown in FIG. 40, in the composite space FK, the fact that the documents BS1 to BS4 and BS17 to BS20, which are a portion of the documents BS1, BS2, . . . existing in the free area AR, are not completely displayed in the free area AR, that is, the documents BS1 to BS4 and BS17 to BS20 are not partially displayed in the free area AR.

Step S82: the CPU 2 forms, as the forming unit 17 (shown in FIG. 2), as shown in FIG. 41, in the virtual space KK, the outer areas SR1 and SR2 outside the free area AR (shown in FIG. 40), for example, outside in a frontage direction, among outside in the direction of the front, outside in the frontage direction, and outside in the depth direction.

Further, the CPU 2 further arranges, as the arrangement unit 14 (shown in FIG. 2), as shown in FIG. 41, in the outer areas SR1 and SR2, some documents among the documents BS1 to BS4 and BS17 to BS20 that are not completely displayed in the free area AR. More specifically, considering the “document importance” (shown in FIG. 4) of the bibliographic information SJ of the documents BS1 to BS4 and BS17 to BS20, and the positions (shown in FIG. 40) of the documents BS1 to BS4 and BS17 to BS20 in the free area AR, in the composite space FK, the CPU 2 arranges the documents in the outer area SR1 on the left side in the order of the document BS2 (or document BS3), the document BS3 (or document BS2), and the document BS1 from the front to the interior so that the documents with higher importance are placed closer to the user, and similarly, the CPU 2 arranges the documents in the outer area SR2 on the right side in the order of the documents BS4, BS18, and BS19 in the direction from the front to the interior.

Note that, in a case where the document no longer needs to be displayed, without considering the importance of the document or the position of the document in a case where the document is displayed in the free area, the document may be displayed in the outer area.

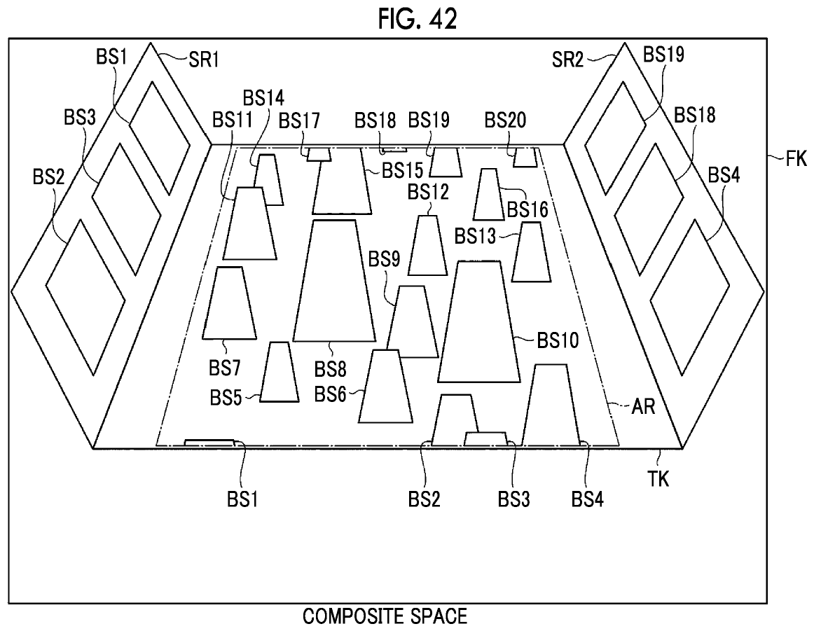

Step S83: the CPU 2 superimposes, as the superimposing unit 15 (shown in FIG. 2), the desk TK in the real space GK (shown in FIG. 8), and the free area AR, the outer areas SR1 and SR2, and the documents BS1, BS2, . . . in the virtual space KK (shown in FIG. 41). As a result, the CPU 2 causes, as the display unit 12 (shown in FIG. 2), the desk TK, the free area AR, the outer areas SR1 and SR2, and the documents BS1, BS2, . . . to be displayed in the composite space FK as shown in FIG. 42.

### Ninth Exemplary Embodiment

An information processing apparatus JS of a ninth exemplary embodiment will be described.

### Configuration of Ninth Exemplary Embodiment

The information processing apparatus JS of the ninth exemplary embodiment has the same configuration and functions as the configuration (shown in FIG. 1) and functions (shown in FIG. 2) of the information processing apparatus JS of the first exemplary embodiment.

### Operation of Ninth Exemplary Embodiment

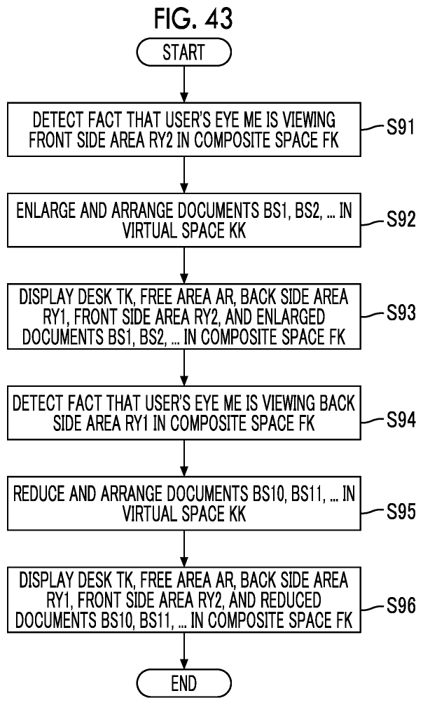

FIG. 43 is a flowchart showing an operation of an information processing apparatus JS of a ninth exemplary embodiment. Hereinafter, the operation of the information processing apparatus JS of the ninth exemplary embodiment will be described with reference to the flowchart of FIG. 43.

In the ninth exemplary embodiment, unlike the first exemplary embodiment in which the sizes of the documents BS1, BS2, . . . are not changed at all, the sizes of the documents BS1, BS2, . . . are changed according to the position where the user's eye is viewing the document and the length of time when the user's eye is viewing the document.

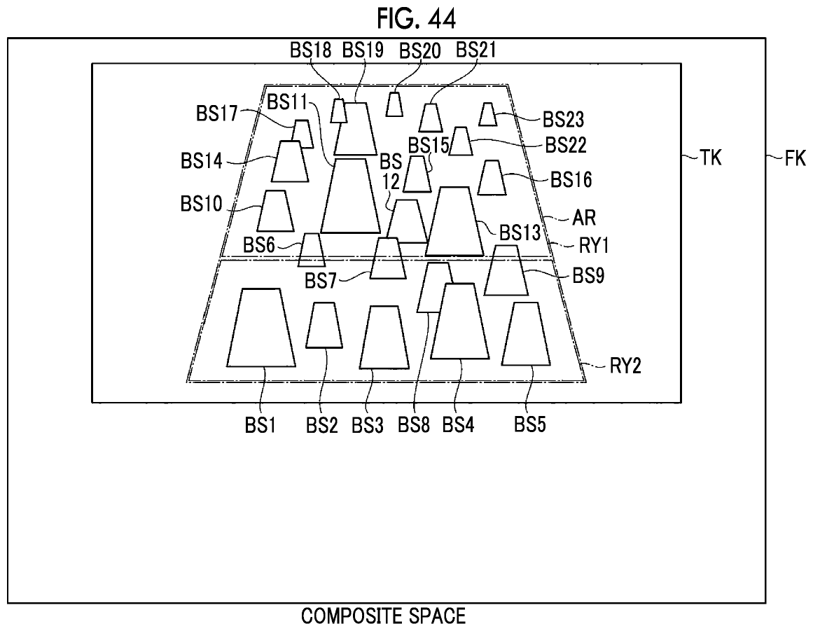

In the following, in order to facilitate the explanation and understanding, as shown in FIG. 44, in the composite space FK, it is assumed that the documents BS1, BS2, . . . are arranged in advance in the inner side area RY1 and the front side area RY2 in the free area AR.

Here, the “inner side area RY1” is an area located in the interior of the free area AR for the user (an area relatively far from the user), and the “front side area RY2” is an area located in front of the free area AR for the user (an area relatively close to the user). The “inner side area RY1” is an example of the “inner area”, and the “front side area RY2” is an example of the “front area”.

Note that, the boundary between the front area and the inner area may be determined in advance at specific positions, or may be optionally designated by the user.

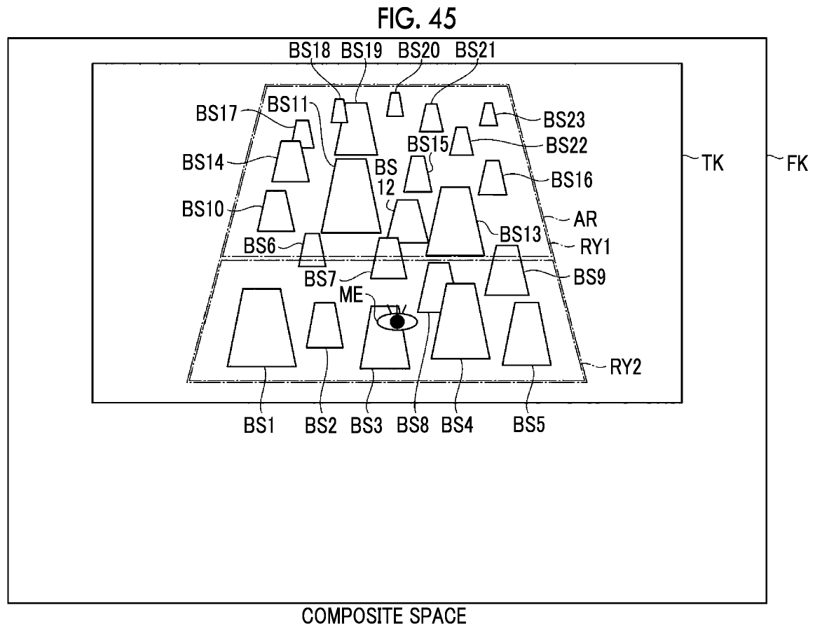

Step S91: in the information processing apparatus JS, the CPU 2 (shown in FIG. 1) detects, as the detection unit 11 (shown in FIG. 2), as shown in FIG. 45, the fact that the user's eye ME is viewing the front side area RY2 in the free area AR, in the composite space FK.

Here, the CPU 2 detects the fact that the user's eye ME is viewing the front side area RY2 by applying an image processing method, for example, “a method using a positional relationship in which the reference point is the inner corner and the moving point is the iris”, and “a method using a positional relationship in which the reference point is the corneal reflex and the moving point is the pupil”, which are well-known methods, to an image photographed by the camera, which is the input unit 1 (shown in FIG. 1).

Step S92: the CPU 2 enlarges and arranges (not shown), as the arrangement unit 14 (shown in FIG. 2), in the virtual space KK, the documents BS1, BS2, . . . in the front side area RY2, in the free area AR. Here, the CPU 2 may enlarge and arrange the documents BS10, BS11, . . . in the inner side area RY1 in accordance with the enlarged arrangement.

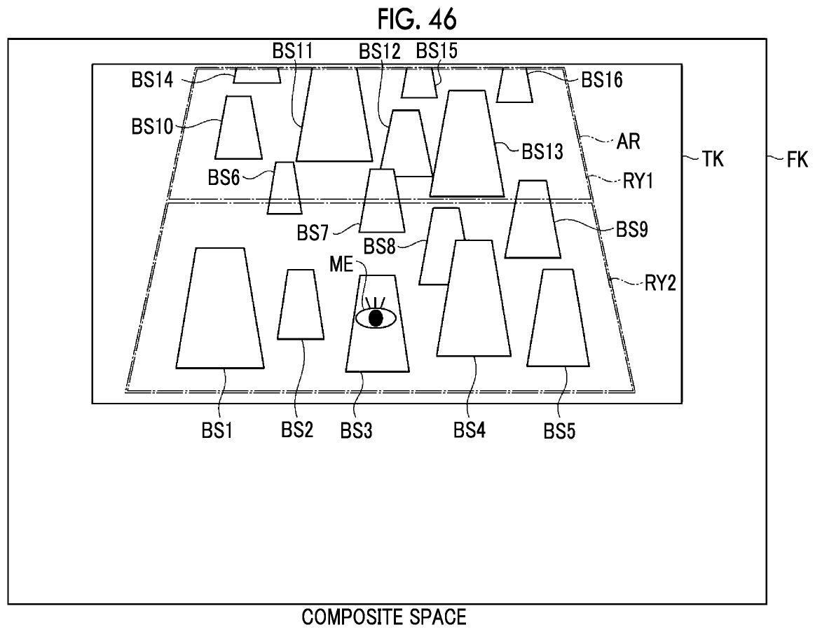

Step S93: the CPU 2 superimposes, as the superimposing unit 15 (shown in FIG. 2), the desk TK in the real space GK (shown in FIG. 8), and the free area AR, the inner side area RY1, the front side area RY2, and the documents BS1, BS2, . . . enlarged in Step S92 in the virtual space KK. As a result, the CPU 2 causes, as the display unit 12 (shown in FIG. 2), the desk TK, the free area AR, the inner side area RY1, the front side area RY2, and the enlarged documents BS1, BS2, . . . to be displayed in the composite space FK, as shown in FIG. 46.

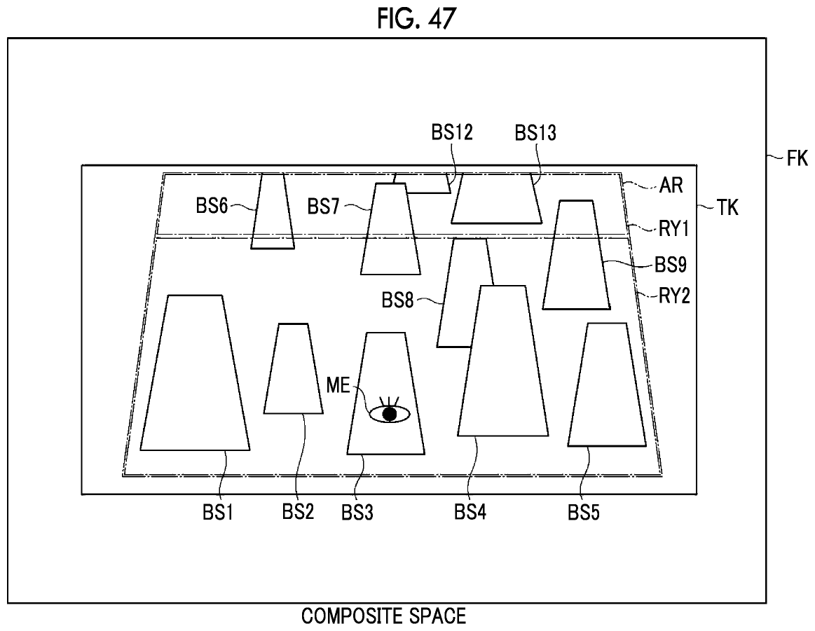

When the CPU 2 performs the arrangement of Step S92, the longer the user's eye is viewing the front side area RY2, the more enlarged the documents BS1, BS2, . . . may be arranged. As a result, in Step S93, the CPU 2 causes, as the display unit 12, the desk TK, the free area AR, the inner side area RY1, the front side area RY2, and further enlarged documents BS1, BS2, . . . to be displayed in the composite space FK, as shown in FIG. 47.

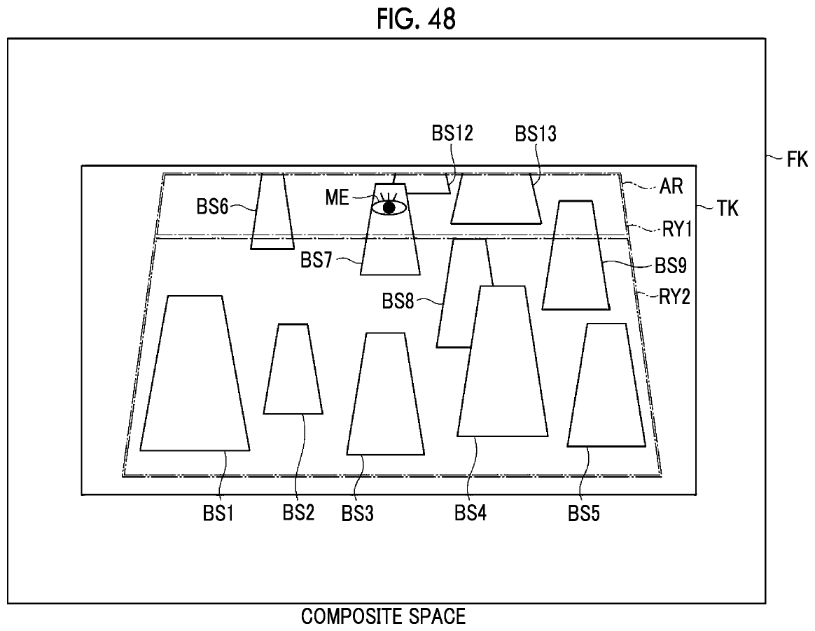

Step S94: in contrast to Step S91 described above, the CPU 2 detects, as the detection unit 11, the fact that the user's eye ME is viewing the inner side area RY1 in the free area AR, in the composite space FK as shown in FIG. 48.

Here, the CPU 2 detects the fact that the user's eye ME is viewing the inner side area RY1 by using, for example, the image processing method described in Step S91.

Step S95: in contrast to Step S92 described above, the CPU 2 reduces and arranges (not shown), as the arrangement unit 14, in the virtual space KK, the documents BS10, BS11, . . . in the inner side area RY1 in the free area AR. Here, the CPU 2 may reduce and arrange the documents BS1, BS2, . . . in the front side area RY2 in accordance with the reduced arrangement.

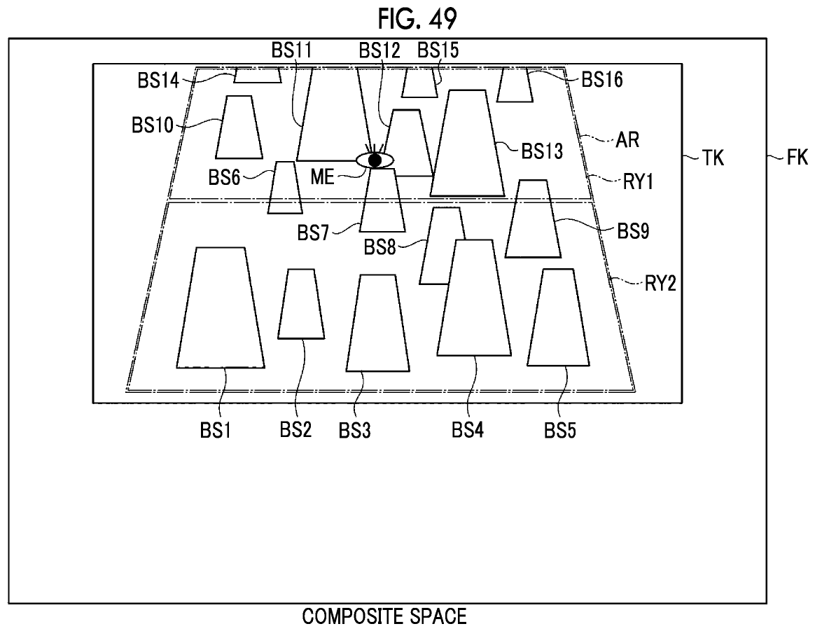

Step S96: the CPU 2 superimposes, as the superimposing unit 15, the desk TK in the real space GK (shown in FIG. 8), and the free area AR, the inner side area RY1, the front side area RY2, and the documents BS10, BS11, . . . reduced in Step S95 in the virtual space KK. As a result, the CPU 2 causes, as the display unit 12, the desk TK, the free area AR, the inner side area RY1, the front side area RY2, and the reduced documents BS10, BS11, . . . to be displayed in the composite space FK, as shown in FIG. 49.

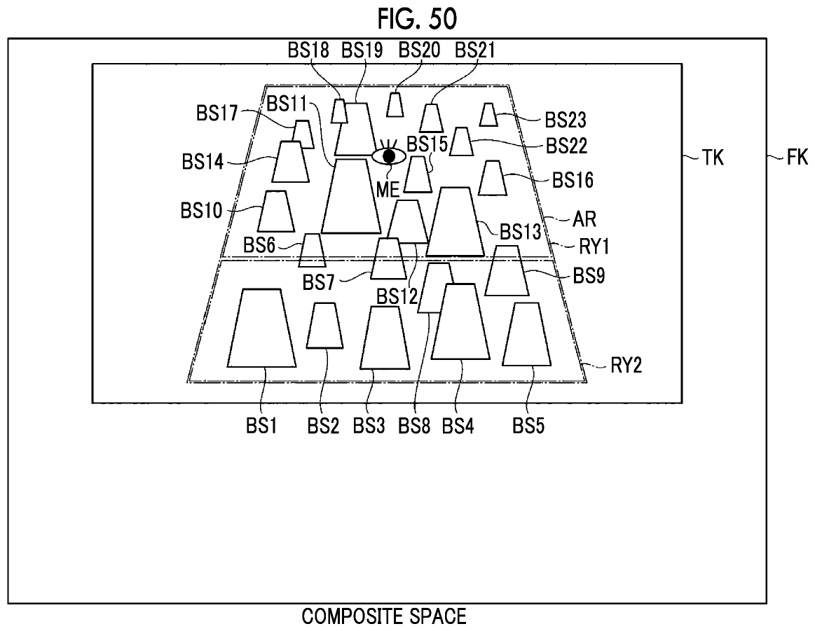

When the CPU 2 performs the arrangement of Step S95, the longer the user's eye is viewing the inner side area RY1, the more reduced the documents BS10, BS11, . . . may be arranged. As a result, in Step S96, the CPU 2 causes, as the display unit 12, the desk TK, the free area AR, the inner side area RY1, the front side area RY2, and the reduced documents BS10, BS11, . . . to be displayed in the composite space FK, as shown in FIG. 50.

Note that, in the ninth exemplary embodiment, the sizes of the documents BS1, BS2, . . . are changed according to the position where the user's eye is viewing the document and the length of time when the user's eye is viewing the document. However, the sizes of the documents BS1, BS2, . . . may be changed according to the position where the user's eye is viewing the document and the time when the user performs the gesture. For example, the document may be enlarged and displayed in a case where the user is viewing the front side area and making a gesture of increasing the distance between the two fingers by the hand, and the document may be reduced and displayed in a case where the user is viewing the inner side area and making a gesture of narrowing the distance between the two fingers by the hand.

### Tenth Exemplary Embodiment

An information processing apparatus JS of a tenth exemplary embodiment will be described.

### Configuration of Tenth Exemplary Embodiment

The information processing apparatus JS of the tenth exemplary embodiment has the same configuration and functions as the configuration (shown in FIG. 1) and functions (shown in FIG. 2) of the information processing apparatus JS of the first exemplary embodiment.

### Operation of Tenth Exemplary Embodiment

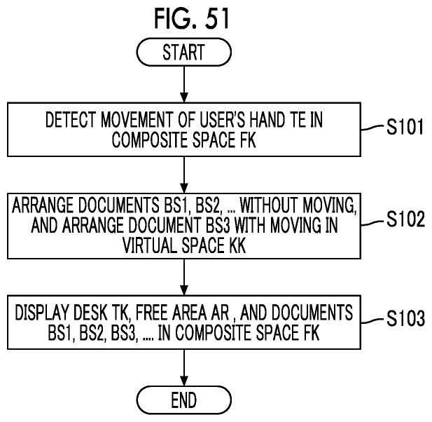

FIG. 51 is a flowchart showing an operation of an information processing apparatus JS of a tenth exemplary embodiment. Hereinafter, the operation of the information processing apparatus JS of the tenth exemplary embodiment will be described with reference to the flowchart of FIG. 51.

In the tenth exemplary embodiment, unlike the first exemplary embodiment in which neither of the documents BS1, BS2, . . . is moved, one of the documents BS1, BS2, . . . is moved.

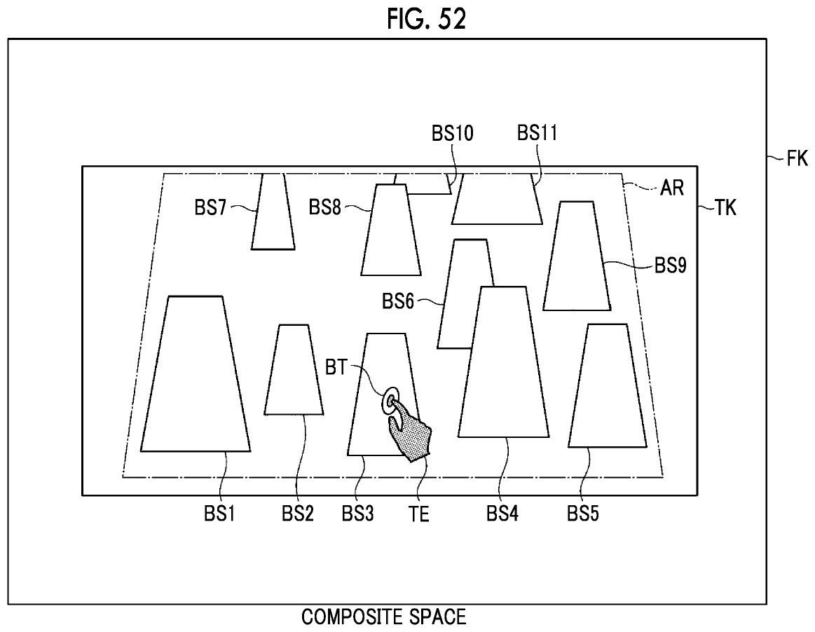

In the following, in order to facilitate the explanation and understanding, as shown in FIG. 52, it is assumed that the documents BS1, BS2, . . . are displayed in advance in the free area AR in the composite space FK.

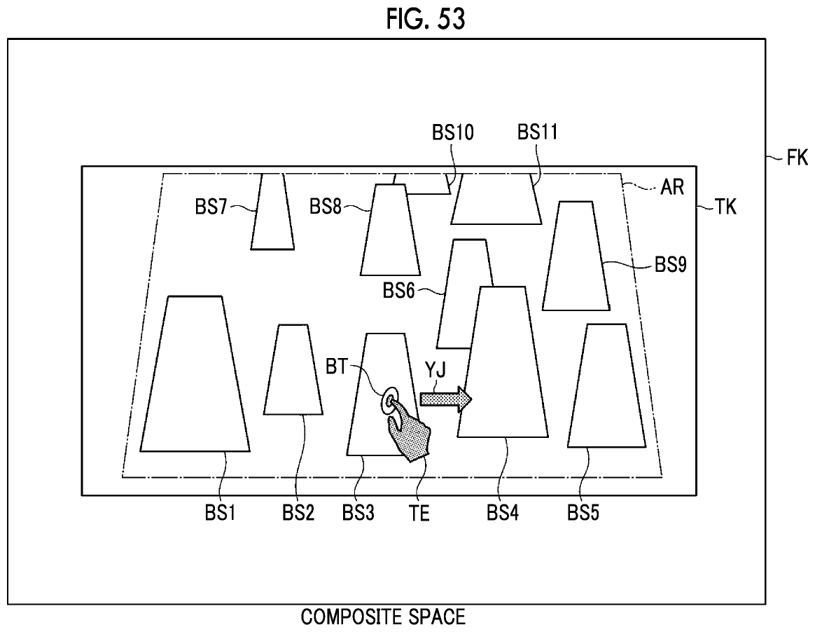

Step S101: in the information processing apparatus JS, the CPU 2 (shown in FIG. 1) detects, as the detection unit 11 (shown in FIG. 2), as shown in FIGS. 52 and 53, in the composite space FK, the fact that the position (for example, a position of a button BT for starting the display in a case where the user's hand TE comes into contact with the button BT) where the user's hand TE comes into contact with moves in the direction of the arrow YJ in FIG. 53 in the free area AR of the desk TK. In other words, the CPU 2 detects a movement (movement instruction) of the hand TE to move the document BS3 existing at the position where the hand TE comes into contact with.

Step S102: the CPU 2 arranges, as the arrangement unit 14 (shown in FIG. 2), in the free area AR in the virtual space KK, the documents BS1, BS2, BS4, . . . other than the document BS3 at the same positions as the positions of BS1, BS2, BS4, . . . shown in FIG. 52, that is, arranges without moving, and arranges the document BS3 at the position after the movement indicated by the arrow YJ in FIG. 53, that is, arranges with moving (not shown).

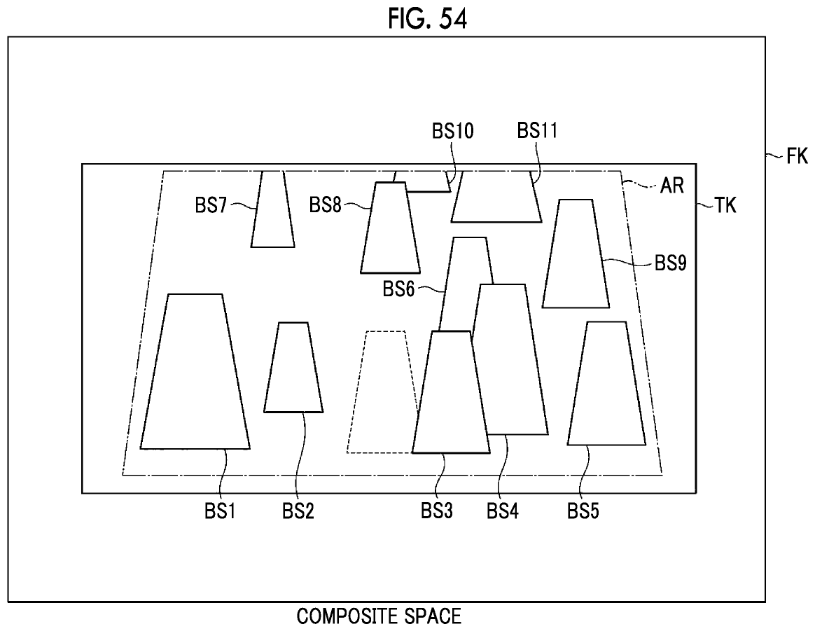

Step S103: the CPU 2 superimposes, as the superimposing unit 15 (shown in FIG. 2), the desk TK in the real space GK (shown in FIG. 8), and the free area AR and the documents BS1, BS2, . . . in the virtual space KK. As a result, the CPU 2 causes, as the display unit 12 (shown in FIG. 2), the desk TK, the free area AR, and the documents BS1, BS2, . . . to be displayed in the composite space FK as shown in FIG. 54. In FIG. 54, the dotted line indicates the position of the document BS3 before a movement.

### Eleventh Exemplary Embodiment

An information processing apparatus JS of an eleventh exemplary embodiment will be described.

### Configuration of Eleventh Exemplary Embodiment

The information processing apparatus JS of the eleventh exemplary embodiment has the same configuration and functions as the configuration (shown in FIG. 1) and functions (shown in FIG. 2) of the information processing apparatus JS of the first exemplary embodiment.

### Operation of Eleventh Exemplary Embodiment

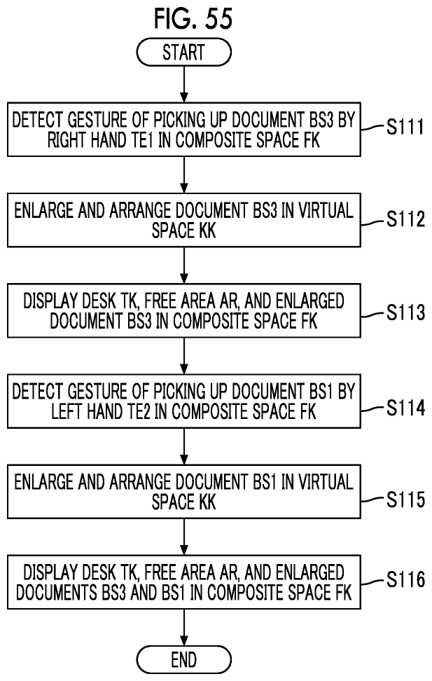

FIG. 55 is a flowchart showing an operation of an information processing apparatus JS of an eleventh exemplary embodiment. Hereinafter, the operation of the information processing apparatus JS of the eleventh exemplary embodiment will be described with reference to the flowchart of FIG. 55.

In the eleventh exemplary embodiment, unlike the first exemplary embodiment in which the documents BS1, BS2, . . . are displayed regardless of the user's operation, the documents BS1, BS2, . . . are enlarged or reduced and displayed in response to the user's operation.

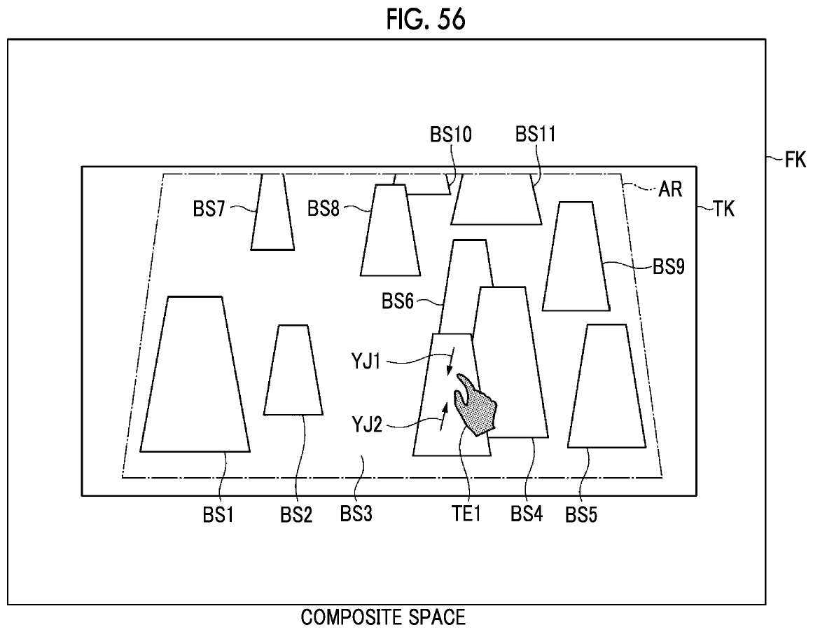

In the following, in order to facilitate the explanation and understanding, as shown in FIG. 56, it is assumed that the documents BS1, BS2, . . . are displayed in advance in the free area AR in the composite space FK.

Step S111: in the information processing apparatus JS, the CPU 2 (shown in FIG. 1) detects, as the detection unit 11 (shown in FIG. 2), as shown in FIG. 56, in the real space GK, a gesture of picking up the document BS3 toward the user by moving the finger of the right hand TE1 in the directions of the arrows YJ1 and YJ2.

Step S112: the CPU 2 enlarges and arranges (not shown), as the arrangement unit 14 (shown in FIG. 2), in the virtual space KK, the document BS3 to be picked up by the user.

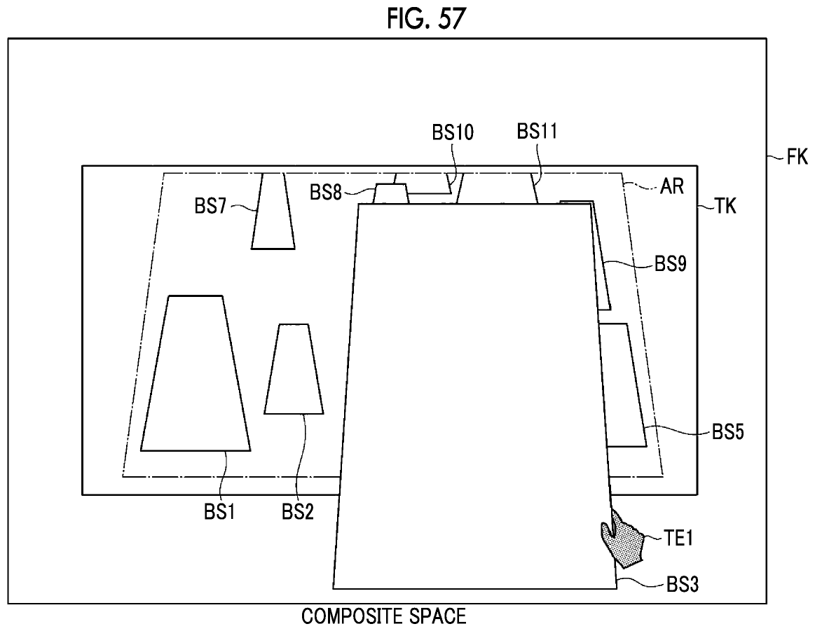

Step S113: the CPU 2 superimposes, as the superimposing unit 15 (shown in FIG. 2), the desk TK in the real space GK (shown in FIG. 8), and the free area AR, the documents BS1, BS2, . . . , and the document BS3 enlarged in Step S112 in the virtual space KK. As a result, the CPU 2 causes, as the display unit 12 (shown in FIG. 2), the desk TK, the free area AR, the documents BS1, BS2, . . . , and the enlarged document BS3 to be displayed in the composite space FK as shown in FIG. 57.

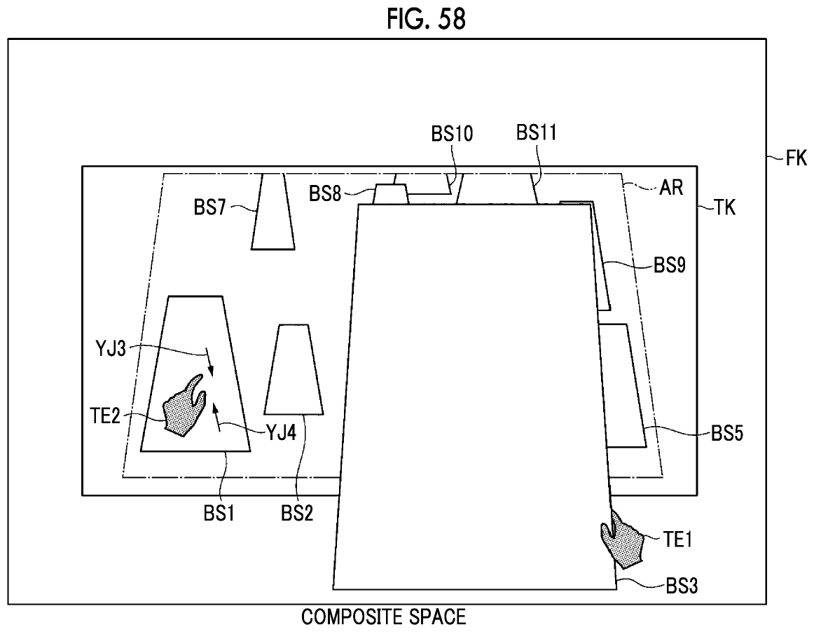

Step S114: in the same manner as in Step S111, the CPU 2 detects, as the detection unit 11, as shown in FIG. 58, in the real space GK, a gesture of picking up the document BS1 toward the user by moving the finger of the left hand TE2 in the directions of the arrows YJ3 and YJ4.

Step S115: in the same manner as in Step S112, the CPU 2 enlarges and arranges (not shown), as the arrangement unit 14, in the virtual space KK, the document BS3 that the user has already made a gesture of picking up and the document BS1 that the user is going to make a gesture of picking up.

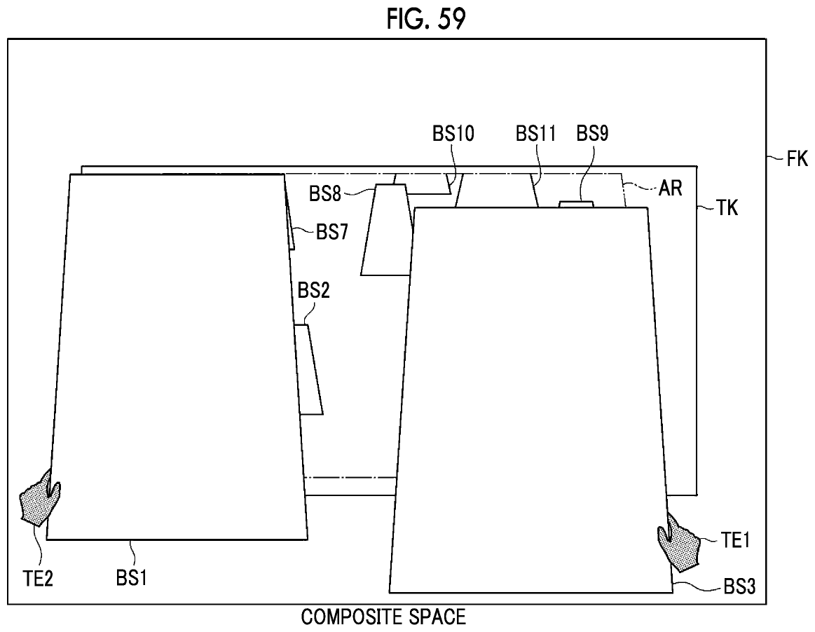

Step S116: in the same manner as in Step S113, the CPU 2 superimposes, as the superimposing unit 15, the desk TK in the real space GK (shown in FIG. 8), and the free area AR, the documents BS2, . . . , the already enlarged document BS3, and the newly enlarged document BS1 in the virtual space KK. As a result, the CPU 2 causes, as the display unit 12, the desk TK, the free area AR, the documents BS2, . . . , and the enlarged documents BS3 and BS1 to be displayed in the composite space FK as shown in FIG. 59.

The operation on a document that is enlarged and displayed by a gesture of picking up toward the user may be more restricted than the operation that is able to be performed on the document in a case of being displayed in the free area.

In a case where a document is picked up by a gesture of picking up, it is often the case that the document is simply viewed. Therefore, for example, a document enlarged and displayed by the gesture of picking up is able to be viewed only, and editing operations such as writing cannot be performed on the document.

On the other hand, the document displayed in the free area is displayed on the desk in the real space, and it is easy to perform editing operations such as writing. Therefore, other than enlarging and displaying the document by performing a gesture of picking up the document toward the user, the functions that are able to be performed may be expanded.

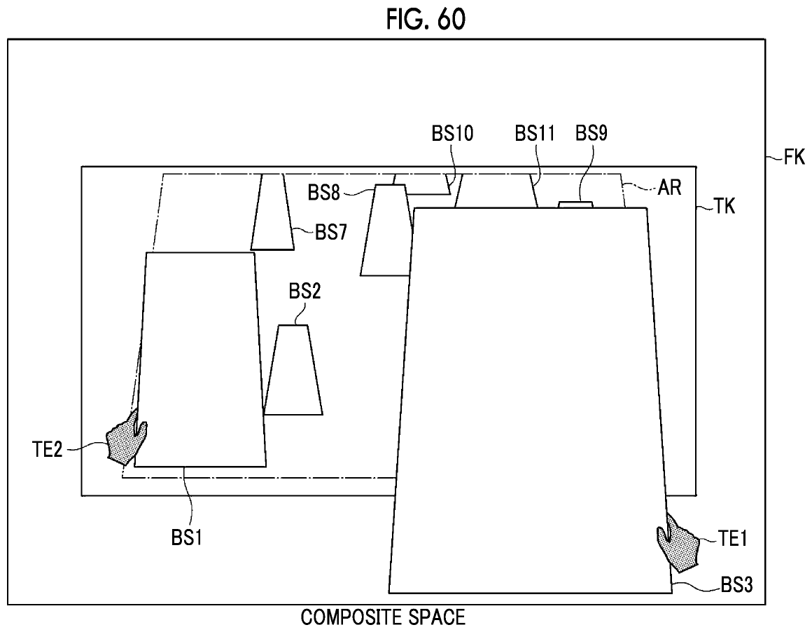

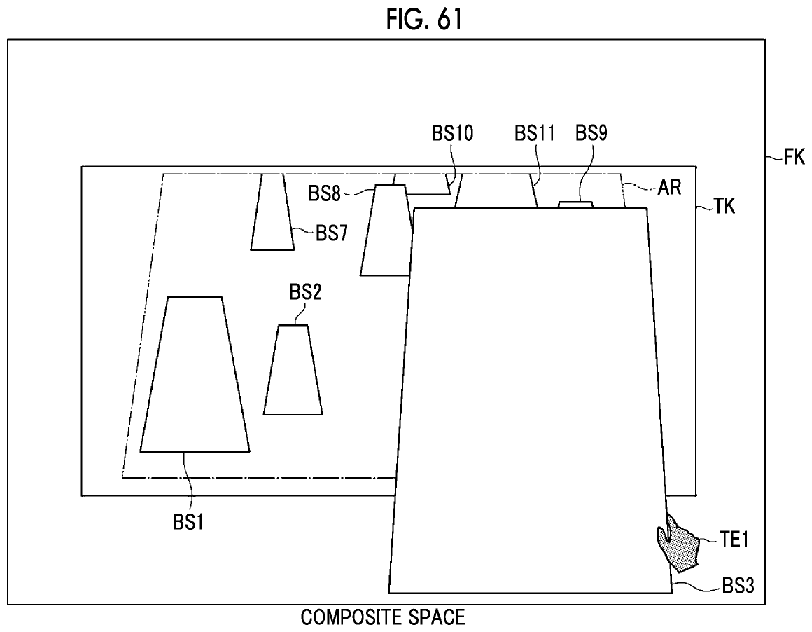

In contrast to Steps S111 to 116 described above, for example, in the composite space FK, as shown in FIG. 60, when the gesture of returning the document BS1 by the user's left hand TE2 (movement of the left hand TE2 in the depth direction) is detected, the CPU 2 may cause the desk TK, the free area AR, the enlarged document BS3, and the original size document BS1 (size shown in FIG. 56) to be displayed in the composite space FK after the document BS1 is reduced and arranged, in the virtual space KK, as shown in FIG. 61.

### Combination of Exemplary Embodiments

It is also possible that the information processing apparatuses JS of the above-described first to eleventh exemplary embodiments are configured and operated by combining the information processing apparatuses JS of two or more exemplary embodiments, instead of being configured and operated independently.

Supplementary Explanation of Processor and Program

In the above-described exemplary embodiment, the processor refers to a processor in a broad sense. In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above-described exemplary embodiment, the program PR may be, instead of being stored (installed) in the storage medium 4 in advance, recorded and provided on a recording medium such as a compact disc read only memory (CD-ROM), a digital versatile disc read only memory (DVD-ROM), and a universal serial bus (USB) memory, or may be downloaded from an external device via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
detect a free area of an object in a real space,
acquire an arrangement of a plurality of virtual objects, and
cause the plurality of virtual objects to be displayed in the free area, in the acquired arrangement.

2. The information processing apparatus according to claim 1,
wherein the processor is configured to
cause the virtual object to be enlarged and displayed as the virtual object is arranged closer to a user.

3. The information processing apparatus according to claim 1,
wherein the processor is configured to
detect an area in which there is no obstacle as the free area, in the object.

4. The information processing apparatus according to claim 2,
wherein the processor is configured to
detect an area in which there is no obstacle as the free area, in the object.

5. The information processing apparatus according to claim 1,
wherein the processor is configured to
cause an auxiliary mark in a virtual space to be displayed, that is obtained by visualizing the free area of the object.

6. The information processing apparatus according to claim 2,
wherein the processor is configured to
cause an auxiliary mark in a virtual space to be displayed, that is obtained by visualizing the free area of the object.

7. The information processing apparatus according to claim 3,
wherein the processor is configured to
cause an auxiliary mark in a virtual space to be displayed, that is obtained by visualizing the free area of the object.

8. The information processing apparatus according to claim 4,
wherein the processor is configured to
cause an auxiliary mark in a virtual space to be displayed, that is obtained by visualizing the free area of the object.

9. The information processing apparatus according to claim 1,
wherein the processor is configured to
cause, in a case where a user gives an instruction to move the plurality of virtual objects to a front of the free area of the object, all of the plurality of virtual objects to be moved in a direction of the front, and cause the moved virtual objects not to be displayed in a case where the moved virtual objects are located outside the free area.

10. The information processing apparatus according to claim 2,
wherein the processor is configured to
cause, in a case where a user gives an instruction to move the plurality of virtual objects to a front of the free area of the object, all of the plurality of virtual objects to be moved in a direction of the front, and cause the moved virtual objects not to be displayed in a case where the moved virtual objects are located outside the free area.

11. The information processing apparatus according to claim 3,
wherein the processor is configured to
cause, in a case where a user gives an instruction to move the plurality of virtual objects to a front of the free area of the object, all of the plurality of virtual objects to be moved in a direction of the front, and cause the moved virtual objects not to be displayed in a case where the moved virtual objects are located outside the free area.

12. The information processing apparatus according to claim 4,
wherein the processor is configured to
cause, in a case where a user gives an instruction to move the plurality of virtual objects to a front of the free area of the object, all of the plurality of virtual objects to be moved in a direction of the front, and cause the moved virtual objects not to be displayed in a case where the moved virtual objects are located outside the free area.

13. The information processing apparatus according to claim 5,
wherein the processor is configured to
cause, in a case where a user gives an instruction to move the plurality of virtual objects to a front of the free area of the object, all of the plurality of virtual objects to be moved in a direction of the front, and cause the moved virtual objects not to be displayed in a case where the moved virtual objects are located outside the free area.

14. The information processing apparatus according to claim 9,
wherein the processor is configured to
cause the virtual object that is not displayed in the free area to be displayed in an outer area located outside the free area.

15. The information processing apparatus according to claim 14,
wherein the processor is configured to
cause, in a case of displaying the virtual object in the outer area, the virtual object to be displayed at a position closer to a user in the outer area as an importance of the virtual object is higher.

16. The information processing apparatus according to claim 1,
wherein the processor is configured to
cause, when a user is viewing a front area of the free area, one or more virtual objects located in the front area among the plurality of virtual objects to be enlarged and displayed.

17. The information processing apparatus according to claim 1,
wherein the processor is configured to
cause, when a user is viewing an inner area of the free area, one or more virtual objects located in the inner area among the plurality of virtual objects to be reduced and displayed.

18. The information processing apparatus according to claim 16,
wherein the processor is configured to
cause the one or more virtual objects to be enlarged or reduced and displayed depending on a length of time when the user is viewing the one or more virtual objects.

19. The information processing apparatus according to claim 1,
wherein the processor is configured to
cause an operation on a virtual object displayed in a case where a user makes a gesture of picking up one or more virtual objects among the plurality of virtual objects from the free area of the object to be restricted more than an operation on a virtual object displayed in the free area.

20. A non-transitory computer readable medium storing an information processing program causing a computer to execute a process, the process comprising:
detecting a free area of an object in a real space,
acquiring an arrangement of a plurality of virtual objects, and
causing the plurality of virtual objects to be displayed in the free area, in the acquired arrangement.
